(19) United States
(12) Patent Application Publication
(10) Pub. No.: US 2023/0289038 A1
(43) Pub. Date: Sep. 14, 2023

(54) ELECTRONIC COOKBOOK AND RELATED METHODS FOR PEOPLE WITH LEARNING DISABILITIES

(71) Applicant: Sarabeth Witbart, Sparta, IL (US)

(72) Inventor: Sarabeth Witbart, Sparta, IL (US)

(21) Appl. No.: 18/319,197

(22) Filed: May 17, 2023

Related U.S. Application Data
(63) Continuation-in-part of application No. 16/520,453, filed on Jul. 24, 2019, now abandoned.
(60) Provisional application No. 62/711,813, filed on Jul. 30, 2018.

(51) Int. Cl. G06F 3/0483; G06T 11/00; G06T 11/60

(52) U.S. Cl. CPC G06F 3/0483; G06T 11/001; G06T 11/60; G06T 2200/24

(57) ABSTRACT

The present disclosure is directed to a cookbook for people with learning disabilities, such as, but not limited to, reading disorders. The cookbook includes a plurality of recipes. Each recipe includes at least one of at least one color-coded measurement and at least one demarcated ingredient section.

### CROSS-REFERENCE TO RELATED APPLICATIONS

This application is a continuation-in-part application of U.S. patent application Ser. No. 16/520,453, filed Jul. 24, 2019, which claims priority to U.S. Provisional Application No. 62/711,813, filed Jul. 30, 2018, the contents of each of which are incorporated herein by reference in their entirety.

### BACKGROUND OF THE DISCLOSURE

The embodiments described herein generally relate to a cookbook for people with learning disabilities, and, more specifically, to specially-formatted recipes with color-coded and/or shape-coded measurement labelling for ingredients and measurement tools to enhance readability and comprehension of the recipes for people with learning disabilities, including reading disorders.

Typical cookbooks and recipes have formats/layouts that are difficult for individuals with a learning disability, such as a reading disorder, to read or interpret. This makes it challenging for those individuals to work independently in the kitchen and to enjoy cooking for themselves or others. There is a need, therefore, to provide a cookbook and recipes to accommodate individuals with learning disabilities that make reading and interpreting each recipe easier.

### BRIEF DESCRIPTION OF THE DISCLOSURE

The present disclosure overcomes the above-described disadvantages by providing specially-formatted recipes including features such as color-coded and/or shape-coded measurement designations/labels, demarcated ingredient sections, directional arrows, and bulleted instructions. The systems and methods disclosed herein also provide color-coded and/or shape-coded measurement identifiers configured to correspond to the color-coded and/or shape-coded measurement labels. Color-coded and/or shape-coded measurements include cup measures (e.g., 1 cup, ½ cup, ⅓ cup, ¼ cup, and ⅛ cup) and tablespoon (T) and teaspoon (tsp) measures (e.g., 1 T, ½ T, 1 tsp, ¾ tsp, ½ tsp, ¼ tsp, and ⅛ tsp).

In one embodiment of the present disclosure, an electronic cookbook configured for display on a display of a computing device is disclosed. The electronic cookbook includes computer-executable instructions that, upon execution by at least one processor of the computing device, cause the at least one processor to display an interactive first graphical user interface (GUI) on the display of the user computing device, the first GUI including: (i) a recipe including at least one color-coded measurement and at least one demarcated ingredient section, wherein a first feature of the recipe is visually enhanced relative to a second feature of the recipe; and (ii) a graphical icon to advance the recipe. The computer-executable instructions also cause the at least one processor to receive, as user input to the display of the user computing device, first user input relative to the graphical icon, and, in response to the first user input, display an interactive second GUI, the second GUI including: the recipe, wherein the second feature of the recipe is visually enhanced relative to the first feature of the recipe, the second feature sequentially following the first feature in performing the recipe.

In another embodiment of the present disclosure, a method for providing an electronic cookbook for display on a display of a computing device including at least one processor and at least one memory is disclosed. The method includes displaying, by the at least one processor, an interactive first graphical user interface (GUI) on the display of the user computing device, the first GUI including (i) a recipe including at least one color-coded measurement and at least one demarcated ingredient section, wherein a first feature of the recipe is visually enhanced relative to a second feature of the recipe; and (ii) a graphical icon to advance the recipe. The method also includes receiving, by the at least one processor, as user input to the display of the user computing device, first user input relative to the graphical icon, and, in response to the first user input, displaying, by the at least one processor, an interactive second GUI, the second GUI including: the recipe, wherein the second feature of the recipe is visually enhanced relative to the first feature of the recipe, the second feature sequentially following the first feature in performing the recipe.

In one embodiment of the present disclosure, a cookbook is disclosed. The cookbook includes a plurality of recipes. Each recipe includes at least one color-coded measurement and at least one demarcated ingredient section.

In another embodiment of the present disclosure, a recipe is disclosed. The recipe includes at least one of the following: at least one color-coded measurement and at least one demarcated ingredient section.

In yet another embodiment of the present disclosure, a method for preparing a recipe is disclosed. The method includes using a cookbook comprising a plurality of recipes. Each recipe includes at least one color-coded measurement and at least one demarcated ingredient section. The method further includes preparing at least one ingredient according to a respective color-coded measurement.

In yet another embodiment, the recipe further includes measurements that are not color-coded and includes ingredients having non color-coded measurements. In these embodiments, the recipe still includes at least one demarcated ingredient section and optionally at least one assembly section, directional arrow, bullet point, action-dividing line, recipe information, image, shopping list, clickable shopping list, clickable ingredient, voice or video button, video clip, audio clip, edge design, and/or page border design.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B depict an exemplary embodiment of a recipe for tater tot casserole in accordance with the present disclosure. FIGS. 1C and 1D are an exemplary embodiment of the recipe shown in FIGS. 1A and 1B with reference numbers added in accordance with the present disclosure.

FIGS. 2A and 2B depict an exemplary embodiment of a recipe for carrot cake in accordance with the present disclosure.

FIGS. 3A and 3B depict an exemplary embodiment of a recipe for green bean casserole in accordance with the present disclosure.

FIGS. 4A and 4B depict an exemplary embodiment of a recipe for lemon chicken in accordance with the present disclosure.

FIGS. 5A and 5B depict an exemplary embodiment of a recipe for cinnamon rolls in accordance with the present disclosure.

FIGS. 6A and 6B depict an exemplary embodiment of a recipe for glazed brussel sprouts in accordance with the present disclosure.

FIG. 7 depicts an exemplary embodiment of a recipe for hash brown pork chops in accordance with the present disclosure.

FIG. 8 depicts an exemplary embodiment of a recipe for marinated pork loin in accordance with the present disclosure.

FIGS. 9A and 9B depict an exemplary embodiment of a recipe for red velvet cake in accordance with the present disclosure.

FIGS. 10A, 10B, and 10C depict exemplary embodiments of measurement identifiers in accordance with the present disclosure.

FIG. 11 depicts an exemplary embodiment of a layering feature in a recipe for tater tot casserole in accordance with the present disclosure.

FIGS. 12A and 12B depict an exemplary embodiment of a bolding feature in a recipe for tater tot casserole in accordance with the present disclosure.

FIG. 13 depicts an exemplary embodiment of a box-in-box feature in a recipe for cheesecake in accordance with the present disclosure.

FIG. 14 depicts exemplary demarcated ingredient sections of a recipe in accordance with the present disclosure.

FIG. 15 depicts exemplary directional arrows of a recipe in accordance with the present disclosure.

FIG. 16 depicts a schematic diagram of an electronic computing device.

FIGS. 17A and 17B depict an exemplary embodiment of a recipe for taco dip in accordance with the present disclosure.

### DETAILED DESCRIPTION OF THE DISCLOSURE

The embodiments described herein include a specially-formatted cookbook and recipes with color-coded and/or shape-coded measurement labels, as well as measurement tool identifiers associated with the respective color-coded and/or shape-coded measurement labels.

Learning disabilities as described herein encompass, without being limited to, disorders and disabilities such as reading disorders, language comprehension deficits, phonological deficits, orthographic processing deficits, vocabulary weaknesses, confusion of mathematical signs and computational processes, generalized language learning disorders, and combinations thereof. Specific reading disorders include, for example, dyslexia and alexia.

In an exemplary embodiment, a cookbook includes a plurality of recipes presented in a graphic organizer style format to benefit individuals with reading disorders. The cookbook may be presented on paper, as a physical cookbook, or as an electronic cookbook that is readable on a display of a computing device (e.g., a laptop, desktop, tablet, smart phone, e-reader, etc.). The term “cookbook,” as used herein, may therefore refer to a physical or digital presentation and should not be understood as limiting in any way.

The cookbook of the present disclosure is configured to present content to a reader, such as reader with a learning disability, in a manner that is more understandable and comprehensible. The features described herein are used in combination to enhance the readability of the cookbook compared to cookbooks that are not designed for readers with learning disabilities. For example, the combination of color, layout, visual features, emphasis (e.g., using bolding features or highlighting/dimming features), font selection, font size and arrangement, selective capitalization, and the like can greatly enhance the readability—and, therefore, the usability—of a cookbook. These features, as described herein, enable enhanced comprehension of the content and flow of a recipe using the placement and “movement” of the shape, color, and text content of a page, while avoiding excessive wording. That is, the overall visual structure of the cookbook enables contextual understanding of a recipe without having to “read” each and every word, which is vastly different from conventional cookbooks.

Each recipe includes at least one color-coded measurement and at least one demarcated ingredient section. For instance, a measurement amount for an ingredient in the recipe is shown as the textual measurement amount and is additionally colored with an assigned color (e.g., red), such as “ [symbol] ”. A different measurement amount is colored with a different assigned color (e.g., green) than the color assigned to the “1 cup” measurement, such as “ [symbol] ”. A particular measurement amount is consistently shown with its assigned color throughout a given recipe. In an exemplary embodiment, the cookbook maintains consistent color-coded measurements across all recipes in the cookbook. For example, the color of the “1 cup” measurement is the same for all recipes in the cookbook. In some embodiments, each measurement amount is additionally or alternatively shape-coded. For example, the textual measurement amount is paired with an assigned shape (such as “▴ 1 cup” and “▪ ½ cup”). In some embodiments, the textual measurement amount is both color-coded and shape-coded (such as “ [symbol] ” and “ [symbol] ”). Depending on the embodiment, the shape itself is or is not shaded, and the shading of the shape is or is not colored. In an exemplary embodiment, a total measurement amount is shown as one or more units of each measurement amount as needed. For example, when a particular ingredient requires 2 and ½ cups, it is listed as two “1 cup” measures and one “½ cup” measure as shown here: [symbol] [symbol] [symbol] .

The use of color-coding and/or shape-coding enhances the readability of a recipe for people with learning disabilities, such as, but not limited to, reading disorders. In particular, the consistent use of a color and/or shape to denote a same measurement amount within a recipe and, moreover, across recipes throughout the cookbook, facilitates enhanced “at a glance” recognition of content, which reduces the requirement to fully read the words or phrases associated with that content while facilitating conceptual comprehension of that content.

Each recipe further includes at least one demarcated ingredient section. In an exemplary embodiment, the demarcation is an open (i.e., 3-sided) square or rectangle that defines a group (or sub-group) of ingredients to be mixed together, added together, and/or prepared together in some way according to the recipe. The ingredients within a demarcated ingredient section are listed with their color-coded measurement amount. Each demarcated ingredient section is configured to separate different ingredient groups from one another. In some embodiments, the lines defining the demarcated ingredient section are colored, and different sections have different-colored lines. In some embodiments, demarcated ingredient sections include text-based instructions associated with the contents of the section, such as “do not stir,” where such text-based instructions are located above the associated section. In some embodiments, a demarcated ingredient section is arranged in a box-in-box (or double box) configuration, where a demarcated ingredient section contains two or more other demarcated ingredient sub-sections and optionally one or more preparation steps (e.g., including one or more directional arrows as described in greater detail herein below) associated with the two or more demarcated ingredient sub-sections contained within the box-in-box demarcated ingredient section. In the example embodiments described herein, the demarcated ingredient sections are designed to be read from top to bottom. Where the box-in-box configuration is employed, the demarcated ingredient sub-sections are further designed to be read from top to bottom in sequence, within the overall demarcated ingredient section.

In at least some embodiments, a demarcated ingredient section is an open shape bounded on three sides, with the top and bottom of the section bounded by straight lines and the right side of the section bounded with an angular shape (e.g., >). This style of demarcation is used, in some embodiments, to indicate a list of ingredients that are not mixed together but rather are layered, one on top of the other, in an order related to the top-to-bottom listed order of the ingredients within the section.

In some embodiments, the recipe further includes an assembly section that shows how particular ingredients or mixtures of ingredients are to be assembled. Lines of text in the assembly section illustrate layers of the dish being prepared. For instance, in some embodiments, a tater tot casserole recipe has an assembly section that shows “tater tots/hamburger mixture/tater tots/cheese”, where each of “tater tots”, “hamburger mixture”, and “cheese” occupy a separate line in a vertical arrangement that mirrors the actual layers of the assembled dish. In some embodiments, the text corresponding to each layer is colored in order to further differentiate between the layers (e.g., “tater tots” text is yellow, “hamburger mixture” text is blue, and “cheese” text is grey). In some embodiments, the color of text corresponding to each layer also corresponds to the color of lines defining the demarcated ingredient section from which that layer came.

In some embodiments, a recipe further includes at least one additional feature. For instance, some embodiments include a directional arrow, a bullet point, recipe information, an image, a ‘master’ ingredient list (i.e., without measurement amounts), a shopping list, an audio clip, a video clip, a ‘stop’ button, a ‘next’ button, and combinations thereof, as described further herein.

In some embodiments, the recipe further includes at least one directional arrow that indicates a preparation step of the recipe. In some embodiments, the directional arrow is either straight or curved, and its direction indicates to a user the order of steps to follow to prepare the recipe. In some embodiments, a directional arrow extends from demarcated ingredient sections to bullet points, between demarcated ingredient sections, between bullet points, or between any other portions of the recipe to indicate a preparation step or piece of useful information. In some embodiments, the directional arrow itself has accompanying text, such as an instruction or piece of useful information. For example, a directional arrow extending from one demarcated ingredient section to another demarcated ingredient section indicates mixing the ingredients from those two sections. The location, shape, and direction of each directional arrow are configured to assist the user in reading and interpreting the recipe while reducing the number of words required to explain the actions in the recipe. For example, a directional arrow points in a direction showing where one group of ingredients (e.g., within a demarcated ingredient section) should be moved (e.g., into or onto location associated with a second group of ingredients identified in a previous or subsequent demarcated ingredient section). As another example, a first directional arrow points from one demarcated ingredient section to an action (e.g., “mix all together”), and a second directional arrow points from another demarcated ingredient section to the same action. These examples illustrate how the directional arrows of the cookbook enhance understanding of the actions taken in a recipe without requiring excessive word-based instructions, as in traditional cookbooks.

In some embodiments, the recipe further includes at least one bullet point that indicates a preparation step and/or piece of useful information for the recipe. Because the bullet points typically contain limited wording, they are beneficial for individuals who have difficulty following lines and/or large blocks of text. In some embodiments, the text content related to each bullet point is arranged in a consistent layout. For example, a list of bullet points may have associated text with a similar width on the displayed page, or with a consistent (limited) number of lines of text. Additionally, patterns of language are repeated where applicable, to enhance readability and rapid comprehension while limiting the number of words used. The cookbook includes bullet point instructions in a same relative location for each recipe, enhancing usability of the cookbook for readers with learning disabilities. Moreover, the bullet point instructions are specifically written and formatted to enhance a reader's comprehension with a limited number of words and action items. For example, the words in a single bullet-point action item may be arranged and formatted such that the first word of each line is contextually relevant. In this way, a reader can “scan” the bullet point to quickly grasp the content of the words, without having to read each individual word in the entire bullet point. In some embodiments, additional instructions with limited wording are included. In some embodiments, ample spacing is provided throughout each recipe page to improve readability of the recipe page.

In some embodiments, the recipe further includes at least one action-dividing line. The action-dividing line serves to divide or separate actions required by the recipe. The action-dividing line separates demarcated ingredient sections, bullet points, and/or directional arrows that are specific to a particular action (or group of actions) required by the recipe. The action dividing lines are thicker or bolder than the lines of the demarcated ingredient sections, to reduce or eliminate the risk of confusion of the relative functions of the lines. In some embodiments, horizontal action-dividing lines are used to divide a recipe into separate processes, visually representing a break in the overall recipe. In some embodiments, vertical action-dividing lines divide a recipe into columns, separating action steps from the demarcated ingredient sections. Horizontal and vertical action-dividing lines can be used in combination within a single recipe. As an example, in a recipe for cinnamon rolls there is an action-dividing line that separates steps of the recipe before the dough rises from steps of the recipe that happen after the dough rises. In some embodiments, the action-dividing line also includes an indicator of the amount of time separating the actions (e.g., “after 15 min”). As another example, in a recipe for marinated pork loin there is an action-dividing line that separates actions required by the recipe one day (such as marinating) from actions required on the next day (such as baking). In this example, the action-dividing line includes an indicator of the amount of time separating the recipe actions (e.g., “next day”). This feature is further exemplified in the Figures described below.

In some embodiments, the recipe further includes recipe information. Recipe information includes a number of servings, prep time, cook time, total time, oven temperature, etc. In some embodiments, the recipe further includes one or more images. The images are an ingredient image, a preparation step image, a completed recipe image, and combinations thereof. The images enable a user to visualize ‘how to’ and ‘what it should look like’ aspects of the recipe. In some embodiments, the ingredient images are at least one different image of the ingredient, such as multiple images showing different brands and/or packaging and/or sizes of the ingredient.

In some embodiments, the cookbook features abbreviations and symbols that are consistent throughout the recipes therein. For example, one abbreviation or symbol is used to indicate that a particular recipe has a small number of ingredients. The abbreviation or symbol may include a “less than” sign (e.g., <) followed by a number. For example, “<7” is printed in a location relative to a recipe to indicate that the associated recipe calls for seven or fewer ingredients. As another example, a snowflake icon is used as an abbreviation within ingredient lists for ingredients that can be purchased frozen (e.g., frozen vegetables), or the snowflake icon is used to indicate a particular recipe is well suited to be refrigerated or frozen after preparing. In some embodiments, another abbreviation or symbol is used to indicate that a recipe involves no cooking. For example, an icon of a crossed-out oven or stove may represent that a corresponding recipe does not involve the use of an oven or stove.

In some embodiments, the recipe further includes at least one shopping list for the recipe. In some embodiments, the shopping lists include at least one image of an ingredient on the list such as multiple images showing different brands and/or packaging and/or sizes of the ingredient.

As described above, in some embodiments, the cookbook is a hardcopy book. In some embodiments, the cookbook is an electronic book and configured to be displayed on an electronic device. The electronic device includes, but is not limited to, an iPad, an iPhone, an Android device, a tablet, a smart phone, a laptop computer, a desktop computer, an electronic reading device (“e-reader”), and any electronic device with a display and/or visual interface, etc. In some embodiments, the recipe further includes an audio clip and/or a video clip. The audio/video clip(s) include preparation steps and/or other useful information associated with the recipe. In some embodiments, the audio/video clip(s) are configured to play automatically, once a recipe is accessed by a reader on their computing device. In some embodiments, the audio/video clip(s) are configured to play upon user selection of a button on the electronic device (such as a physical button) or on the display of the electronic device (such as a virtual or touchscreen button or icon).

In some embodiments, additional electronic device buttons or icons include a ‘next’ button (such as a next/go/play/advance/forward type button) that allows a user to advance through a visually displayed progression of ingredients and/or steps of a recipe. For example, upon selection of the next button, an ingredient and/or step of the recipe will be visually emphasized (as discussed in greater detail herein below). Subsequent ingredients and/or steps of the recipe are visually emphasized either automatically or manually. In embodiments where subsequent ingredients and/or steps are visually emphasized automatically, a first ingredient (or group of ingredients) and/or step (or group of steps) is emphasized for a certain amount of time after which the first ingredient/step becomes deemphasized and a second (or next, such as according to a progression of the recipe) ingredient/step becomes emphasized for a certain amount of time. In embodiments where subsequent ingredients and/or steps are visually emphasized manually, a user must select the ‘next’ button each time they want to change visual emphasis of ingredients/steps (such as according to a progression of the recipe). For example, in some embodiments, a triangular-shaped button is used to indicate a “next” display command. The electronic cookbook includes instructions that cause the sequential display of the ingredients and/or steps of the recipe, responsive to the user input from the reader.

In some embodiments, a ‘back’ or ‘previous’ button is also included on the electronic device (or on a display of the electronic device) that allows a user to visually emphasize previous or earlier ingredients/steps of the recipe. For example, in some embodiments, another triangular-shaped button (e.g., pointing in a different direction than a direction of the “next” command) may be used to indicate a “previous” display command.

When a user clicks on the triangular-shaped button to advance through the recipe, a particular step in the recipe is slightly bolded, and every time the user clicks the triangular-shaped button after that, it will operate as a “next” button and moves the user through the recipe. This will also include any actions necessary regarding boxes, arrows with instructions (e.g., “mix in mixer”), etc. In some embodiments, the cookbook also includes a ‘stop’ button that allows a user to stop or pause the visually displayed progression of the ingredients and/or steps of the recipe. For example, a button in the shape and/or color of a stop sign is used (e.g., an octagon, or a red octagon). To end the recipe, a user clicks the stop sign.

In some embodiments, a printable version of the cookbook is associated with the electronic cookbook. In some embodiments of the electronic cookbook, the shopping list is ‘clickable’ such that a user clicks on (or selects) an ingredient on the shopping list to view one or more images of that particular ingredient. Additionally or alternatively, an ingredient within the recipe itself is ‘clickable’ such that a user clicks on (or selects) an ingredient listed within the recipe itself to view one or more images of that particular ingredient. For example, selecting a listed ingredient will cause display of one or more “genericized” images representing the most popular brand(s) for that ingredient. In this way, users can more readily recognize ingredients on store shelves based on their visual appearance, rather than relying on reading brand names or item titles.

In some embodiments, each recipe of the cookbook includes a specific edge design or page border design that is based on a category of the dish/recipe. For example, “main dish” (e.g., entrée, etc.) recipes have a different edge/border design than dessert recipes.

In some embodiments, the recipe further includes measurements that are not color-coded. For example, the recipe includes ingredient measurements that do not require a color-coded measurement, such as 2 lb (1 bag) frozen tater tots, 2 lb hamburger, salt & pepper, ¼ onion (cut up), 12 oz. (1 bag) frozen corn, 3 eggs, 1½ sticks butter, 43.5 oz. (3 cans) green beans, 3 chicken breasts, juice of 2 lemons, 1 package dry yeast, etc. In some embodiments, the recipe only includes ingredients having non color-coded measurements. That is, in some embodiments, the recipe does not include at least one color-coded measurement. In these embodiments, the recipe still includes at least one demarcated ingredient section and optionally at least one assembly section, directional arrow, bullet point, action-dividing line, recipe information, image, shopping list, clickable shopping list, clickable ingredient, voice or video button, video clip, audio clip, edge design, and/or page border design, as described above.

In some embodiments, measurement identifiers are additionally included with the cookbook. The measurement identifiers are color-coded and associated with a respective color-coded measurement. For example, a set of colored zip ties is provided with the cookbook which the user attaches to the corresponding measurement tool according to the color-coding of the cookbook recipe measurements. In some embodiments, an illustration is provided to show a user how to match measuring tool sizes with their respective color-coded identifier according to the recipe or cookbook. As another example, a set of colored stickers or tape is provided with the cookbook. In some embodiments, the identifiers are further shape-coded. In some embodiments, at least one set of measurement tools is additionally provided with the cookbook wherein the measurement identifiers are integrated into the measurement tools themselves, such as by incorporating a colored label onto measuring cups and spoons, incorporating colored lines or markings onto liquid measuring tools, or by coloring all or part of the measuring tool (e.g., the handle only, the measurement end only, or the entire tool). For example, colored sets of measurement cups (such as 1 cup, ½ cup, ⅓ cup, ¼ cup, and ⅛ cup measures) and spoons (such as 1 T, ½ T, 1 tsp, ¾ tsp, ½ tsp, ¼ tsp, and ⅛ tsp measures) are provided with the cookbook. In some embodiments, a liquid measuring tool (or tools) is also provided with the cookbook. In some embodiments, the measurement identifiers on the liquid measuring tool correspond (i.e., have the same color and/or shape) to the dry measuring tool identifier having the same size measurement. In other embodiments, the measurement identifiers on the liquid measuring tool do not correspond (i.e., do not have the same color and/or shape) to the dry measuring tool identifier of the same size measurement.

In embodiments where the cookbook or recipes are displayed electronically, such as in an electronic cookbook, one or more graphical effects or visual features are included, such as visually emphasizing features that are configured to draw attention to or highlight various components of a recipe. In some embodiments, a visually emphasizing feature is in the form of layering, such as in recipes that include an assembly section illustrating layers of a dish being prepared. In these embodiments, a user selects (e.g., touches) a layer listed in the assembly section of the recipe and the layering feature is activated by dimming (or visually deemphasizing in some other way) ingredients and/or steps of the recipe that are not associated with preparation of the selected layer. Consequently, the ingredients and/or steps associated with the selected layer are visually emphasized on the electronic display, such as for convenience to the user when preparing that particular layer of the dish. In some embodiments, a subsequent selection (e.g., touch) of the assembly section layer deactivates the layering feature. Another layer listed in the assembly section can then be selected for visual emphasis via the layering feature. In some embodiments, the layering feature is activated and deactivated manually or automatically. In some embodiments, the layering feature is available for other recipe components (e.g., ingredients, preparation steps, bullet points, etc.) that are not part of an assembly section of a recipe. In some embodiments, the layering feature is used concurrently with other graphical effects and/or visually emphasizing features.

In some embodiments, a visually emphasizing feature is in the form of bolding. In these embodiments, a user selects (e.g., touches) an ingredient or step and the bolding feature is activated, such that the selected item text becomes bold and thus visually emphasized over other items on the electronic display of the recipe. In some embodiments, a subsequent selection (e.g., touch) of the item deactivates the bolding feature. In some embodiments, the bolding feature is activated and deactivated manually or automatically. In some embodiments, visual emphasis of recipe components is additionally or alternatively indicated by highlighting (such as colored highlighting) effects, encircling effects, dimming/brightening effects, enlarging/shrinking effects, pointer/indicator effects, etc. In some embodiments, the bolding feature is available for other recipe components (e.g., preparation steps, assembly section layers, etc.) alternatively or in addition to recipe ingredients. In some embodiments, the bolding feature is used concurrently with other graphical effects and/or visually emphasizing features.

In some embodiments, the arrangement of the recipes throughout the cookbook is consistent. For example, the location of the shopping list, image(s), demarcated ingredient sections, and bullet-point action items are consistently located relative to one another, in every recipe in the cookbook. Such a feature enhances readability and useability of the cookbook, specifically for readers with learning disabilities. Additionally, in some embodiments, the specific features of the font, colors, and layout are all selected to enhance the readability of the cookbook. For example, sans-serif fonts, which have been shown to enhance readability in some situations, are chosen, and larger fonts sizes, along with fewer words, are used. The placement and size of certain visual features also provide contextual significance without reliance on additional words. For example, top-to-bottom ingredient sections and action items visually represent the order of operations in performing a recipe. A wider demarcated ingredient section is rapidly visually distinguished from a narrower demarcated ingredient section, which makes it easier for readers to differentiate between sections and associated instructions. In some embodiments, selective capitalization and/or other changes in font characteristics are used to enhance rapid comprehension. For example, temperature indicators are designated with “low”/“Low”, medium temperature indicators are designated with “MediuM”, and high temperature indicators are designated with “HIGH.” In this way, a reader can also use the context of font size/capitalization to more readily understand the content of the words, enabling quick identification of text content without having to fully read a word.

Various features disclosed herein are further exemplified in the Figures described below.

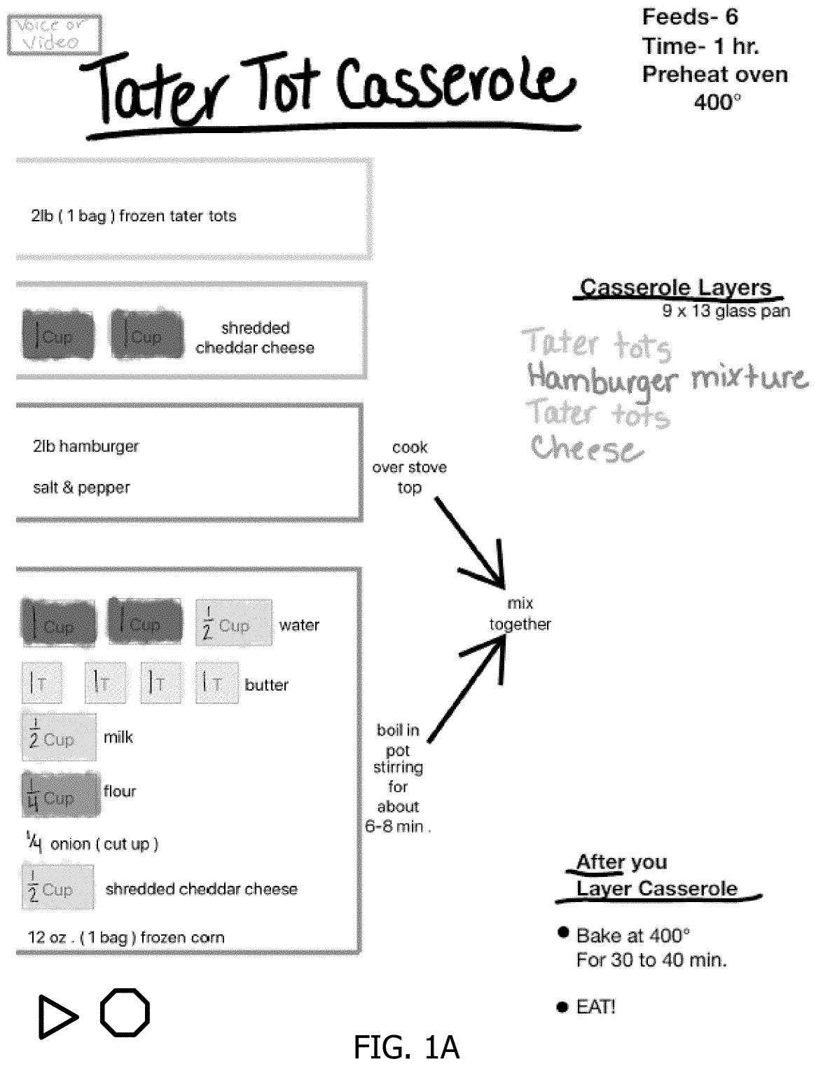

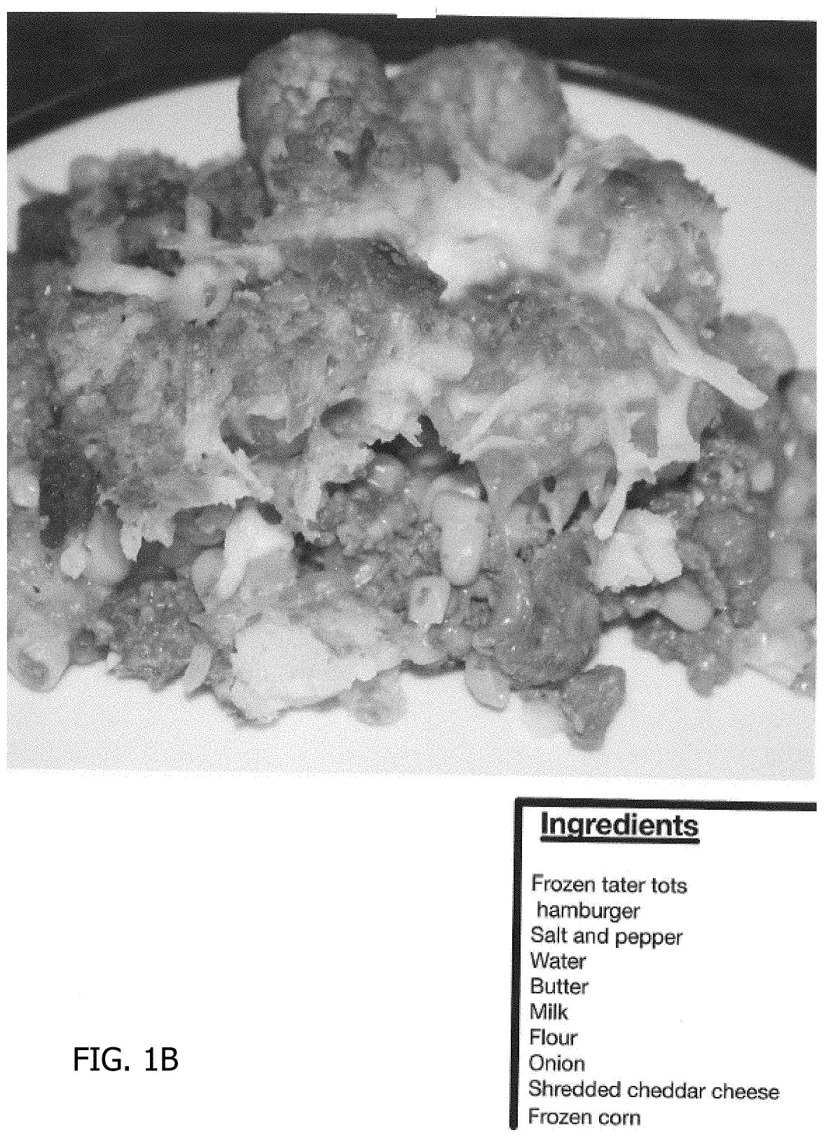

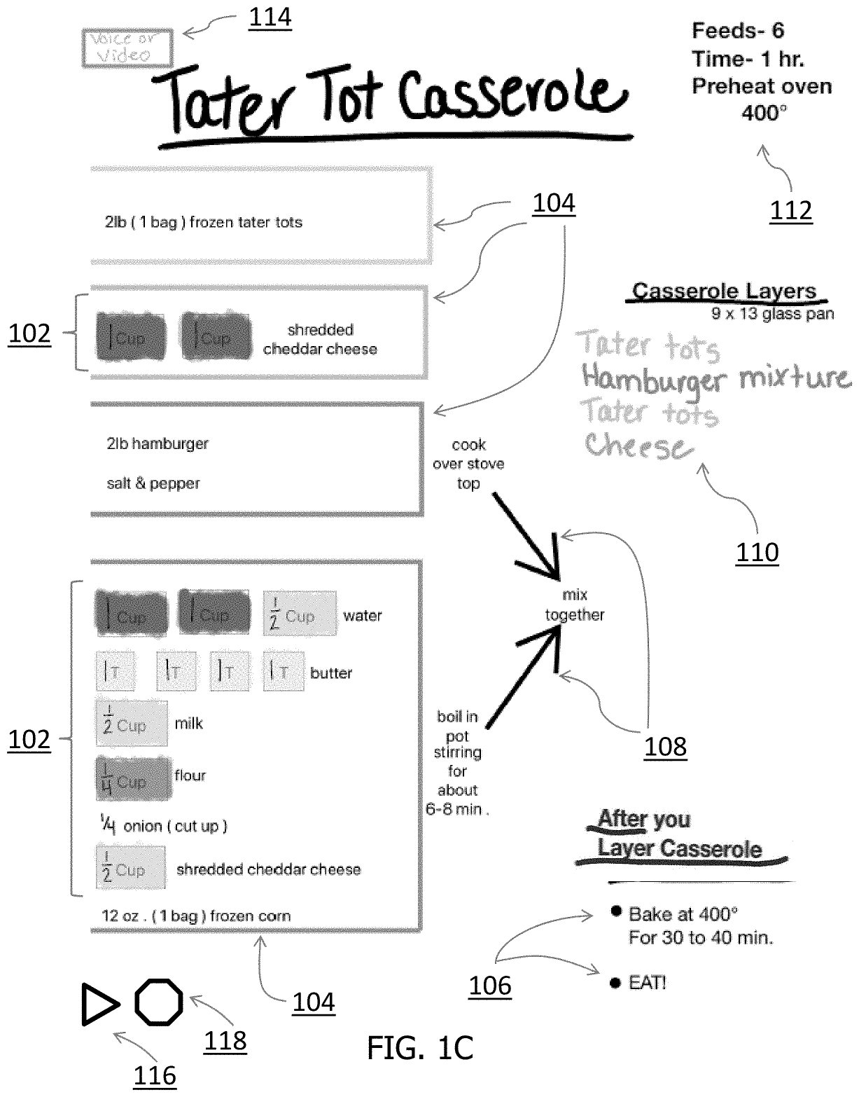

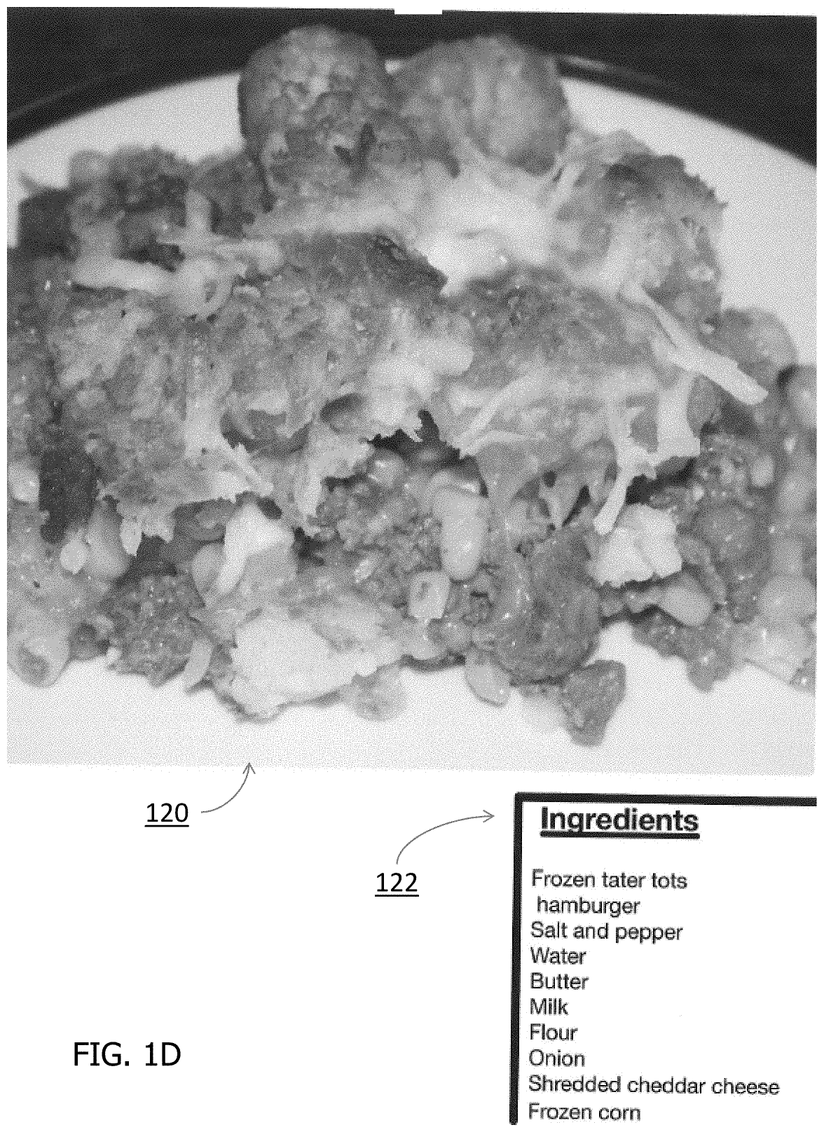

FIGS. 1A and 1B show an exemplary embodiment of a recipe for tater tot casserole in accordance with the present disclosure. FIGS. 1C and 1D show the recipe for tater tot casserole with reference numbers to be described herein below. In FIG. 1C, color-coded measurement amounts 102 are shown for various ingredients. Demarcated ingredient sections 104 are used to demarcate and separate four sets/groups of ingredients and are shown with colored lines. The line color of each demarcated ingredient section 104 corresponds to a casserole layer illustrated in assembly section 110. Assembly section 110 utilizes both text and color to indicate each layer. Bullet points 106 show various preparation steps for the recipe. Directional arrows 108 are straight in this particular embodiment and indicate ingredients that are to be mixed. The tater tot casserole recipe further includes recipe information 112, a ‘voice or video’ button 114 (e.g., in embodiments where the cookbook/recipe is in an electronic form), and ample spacing. Additional buttons include a ‘next’ button 116 and a ‘stop’ button 118 (e.g., in embodiments where the cookbook/recipe is in an electronic form). In FIG. 1D, the tater tot casserole recipe further includes an image 120, a shopping list 122, non-color-coded measurements, and ample spacing. Image 120 shows an image of the finished dish/recipe.

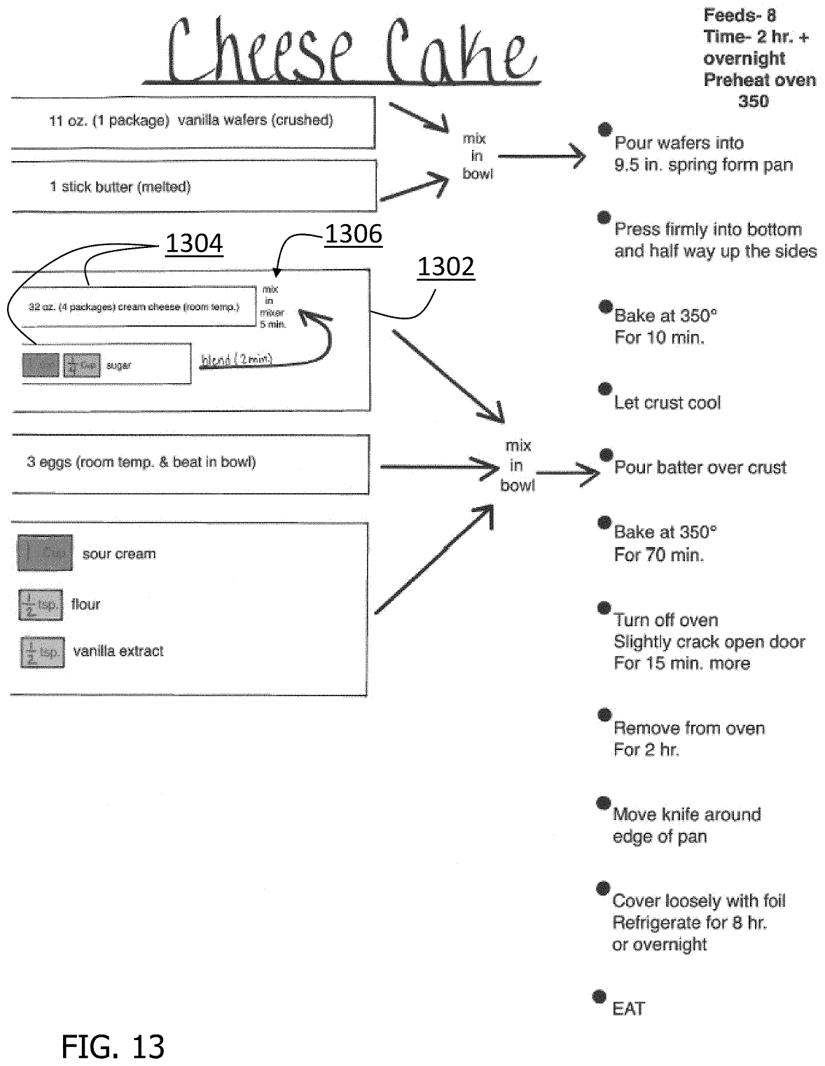

FIG. 13 shows an exemplary embodiment of a box-in-box feature in a recipe for cheesecake in accordance with the present disclosure. In some embodiments, a demarcated ingredient section is arranged in a box-in-box (or double box) configuration, where a demarcated ingredient section 1302 contains two or more other demarcated ingredient sub-sections 1304 and optionally one or more preparation steps 1306 (e.g., including one or more directional arrows as described in greater detail herein below) associated with the two or more demarcated ingredient sub-sections 1304 contained within the box-in-box demarcated ingredient section 1302. In the embodiment shown, two demarcated ingredient sub-sections 1304 (cream cheese and sugar) are shown in a box-in-box demarcated ingredient section configuration, along with preparation steps 1306 (‘mix in mixer 5 min.’ and ‘blend’) and a directional arrow associated with the two ingredients sub-sections 1304 contained within the box-in-box demarcated ingredient section 1302. In addition to demarcated ingredient sections (e.g., both box-in-box (i.e., double box) and non-box-in-box (i.e., single box)), FIG. 13 also includes color-coded measurements, bullet points, directional arrows, recipe information, non-color-coded measurements, and ample spacing.

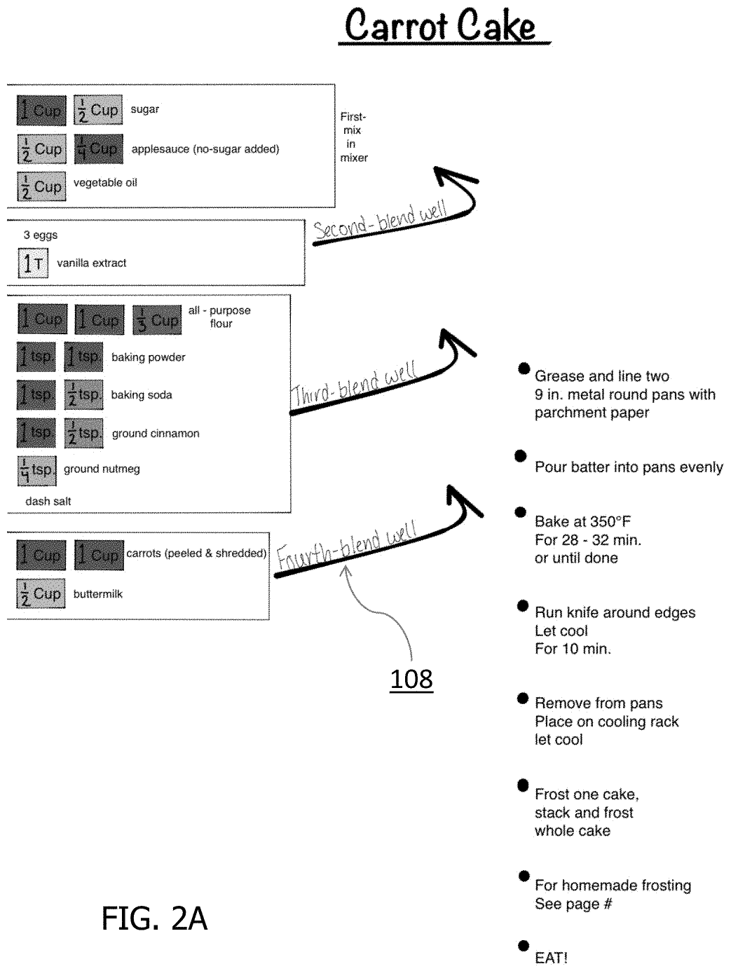

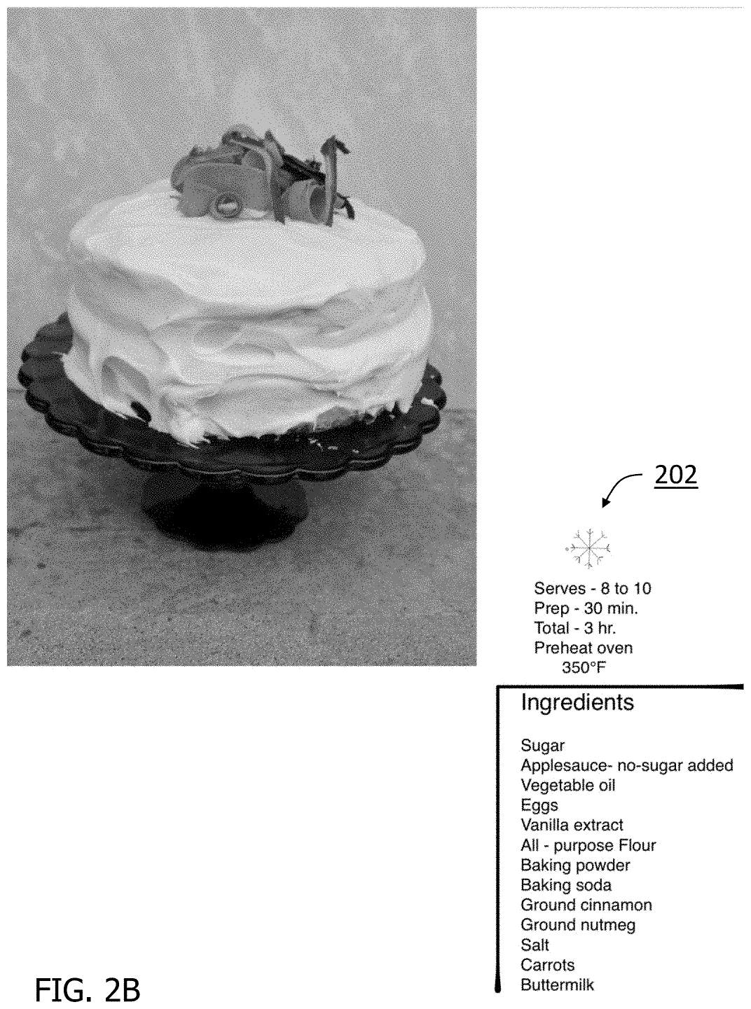

FIGS. 2A and 2B show an exemplary embodiment of a recipe for carrot cake in accordance with the present disclosure. FIG. 2A includes color-coded measurement amounts, demarcated ingredient sections, bullet points, directional arrows 108 (which are curved in this particular embodiment), non-color-coded measurements, and ample spacing. Additionally, the demarcated ingredient sections are all different widths (e.g., the sections get narrower from top to bottom), which enables a reader to more quickly and easily distinguish between separate sections. Moreover, this variable width, in combination with the varying width of the sequential directional arrows, emphasizes the order of the instructions in performing the recipe. The bullet-point instructions (also referred to as “action items” or “steps”) also include limited words and a limited number of lines (e.g., a maximum of three lines). The first word of each line within a bullet point is specifically selected for rapid comprehension of the content of the instruction. For example, “Bake—For—or” in the third bullet point enables a reader to very quickly understand that the instruction is calling for “Baking” the ingredients “For” some length of time, “or” some alternative objective. Likewise, “Run—Let—For” in the next bullet point enables the reader to very quickly understand that the instruction is calling for “Run”ing the knife around the edges of the pan, “Let”ting the cake cool, “For” a specific amount of time. Selective and consistent capitalization (e.g., capitalizing the action words, such as “Bake”, “Remove,” etc., as well as the time increments that are specific, such as “For 28-32 min.”, “For 10 min.”, etc.) further enhances the rapid understanding of the instructions. FIG. 2B includes an image of the finished dish, a shopping list, and ample spacing. Additionally, an abbreviation 202, embodied as a snowflake icon, is displayed, indicating the recipe can be refrigerated or frozen. Recipe details (e.g., number of servings, preparation time, total time, and oven temperature) are also depicted.

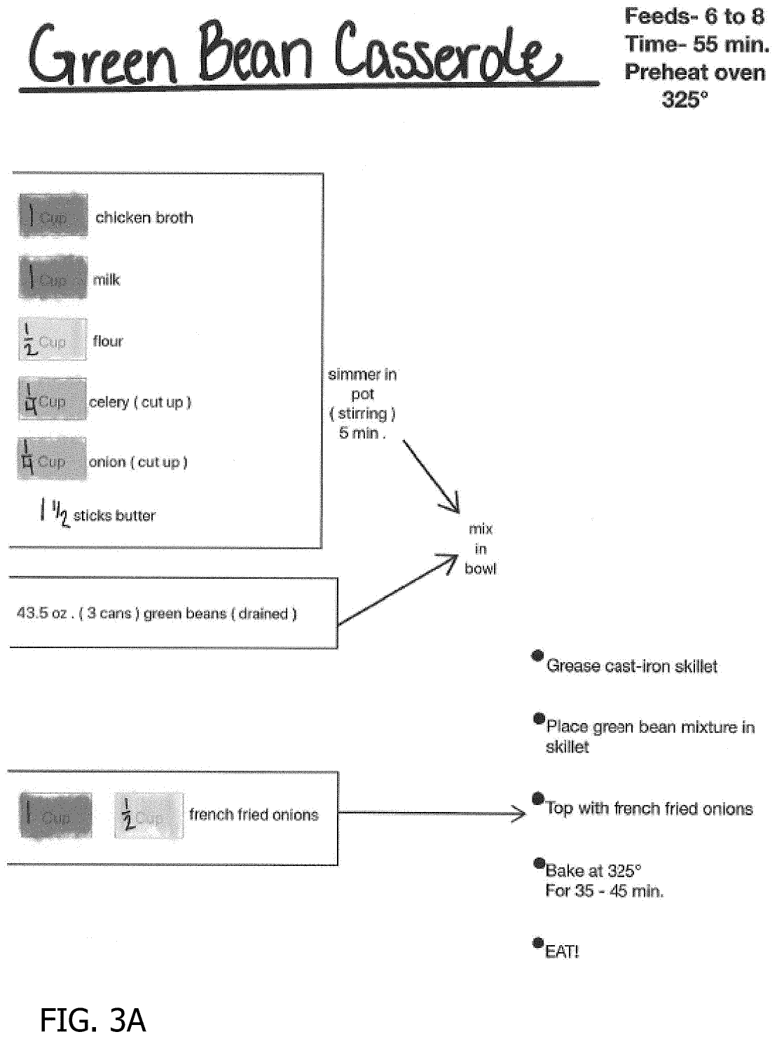

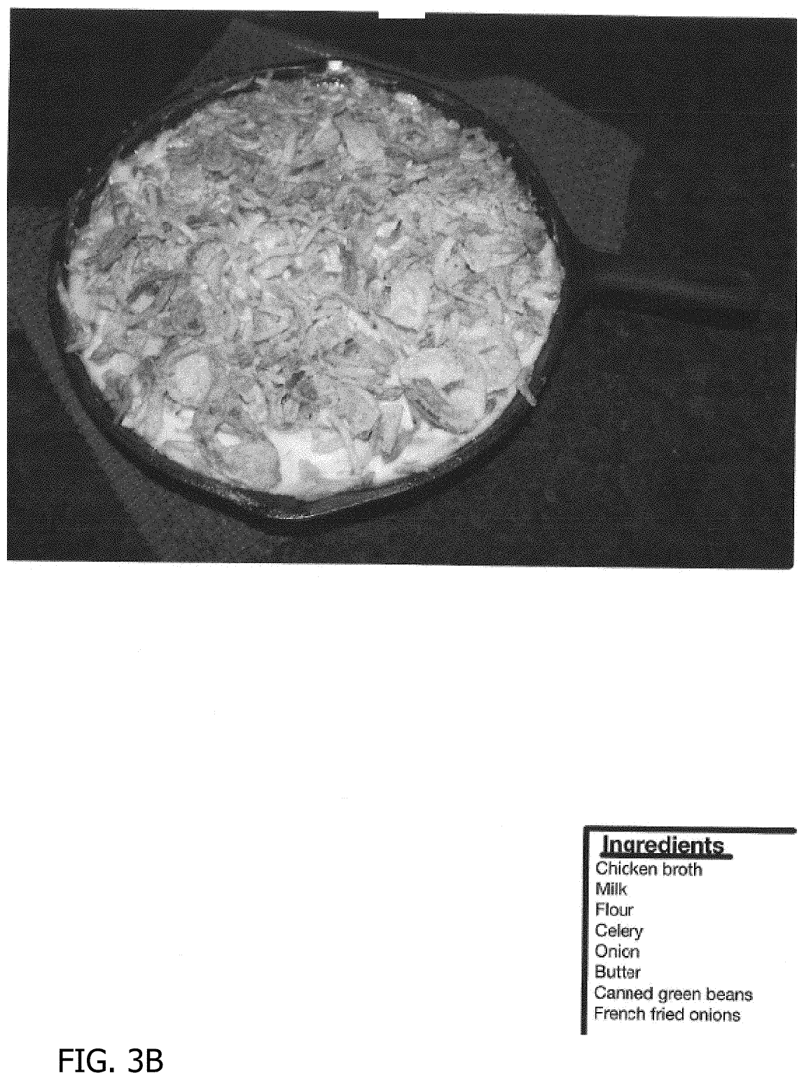

FIGS. 3A and 3B show an exemplary embodiment of a recipe for green bean casserole in accordance with the present disclosure. FIG. 3A includes color-coded measurement amounts, demarcated ingredient sections, bullet points, directional arrows, recipe information, non-color-coded measurements, and ample spacing. FIG. 3B includes an image of the finished dish, a shopping list, and ample spacing.

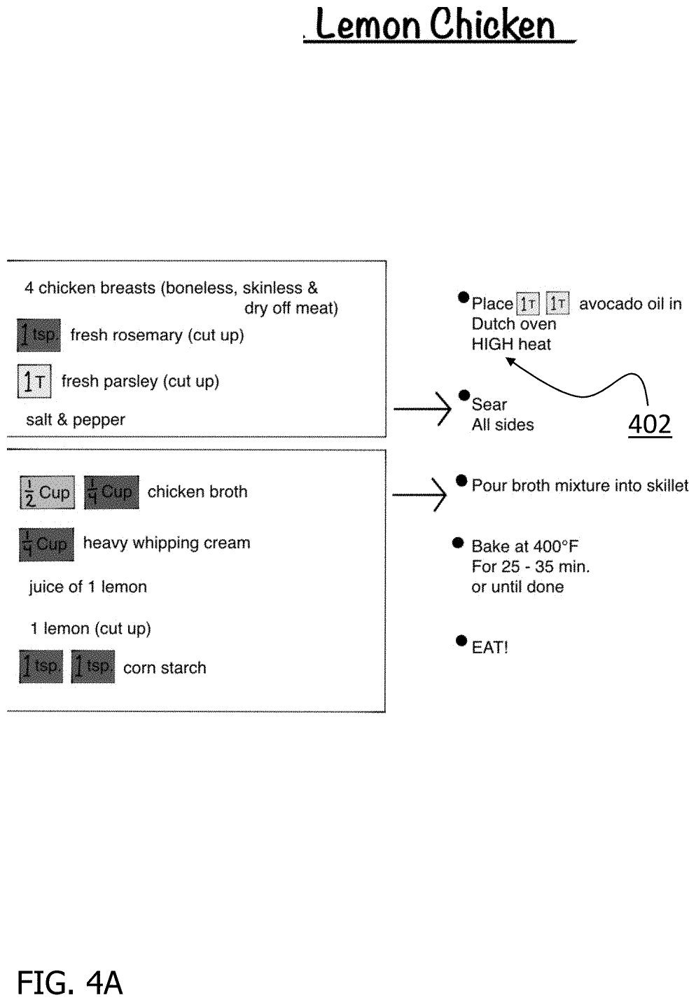

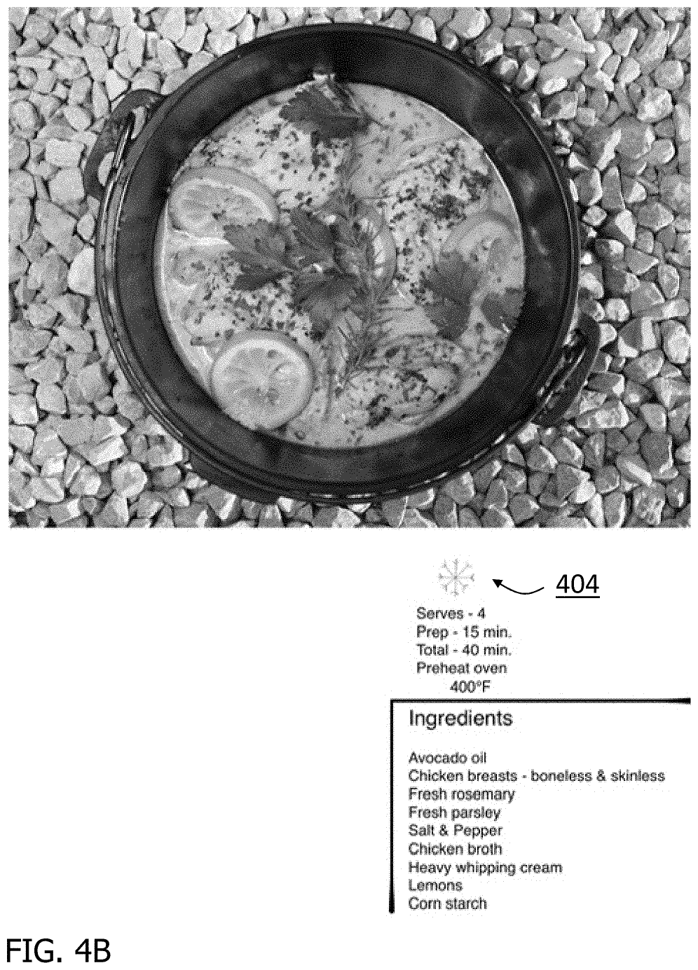

FIGS. 4A and 4B show an exemplary embodiment of a recipe for lemon chicken in accordance with the present disclosure. FIG. 4A includes color-coded measurement amounts, a demarcated ingredient section, a directional arrow, bullet points, non-color-coded measurements, and ample spacing. Additionally, an example of selective capitalization 402 is depicted, in which a temperature indicator is displayed as “HIGH,” in all capital letters, which enhances contextual understanding of the word. FIG. 4B includes an image of the finished dish, a shopping list, and ample spacing. Additionally, an abbreviation 404, embodied as a snowflake icon, is displayed, indicating the recipe can be refrigerated or frozen. Recipe details (e.g., number of servings, preparation time, total time, and oven temperature) are also depicted.

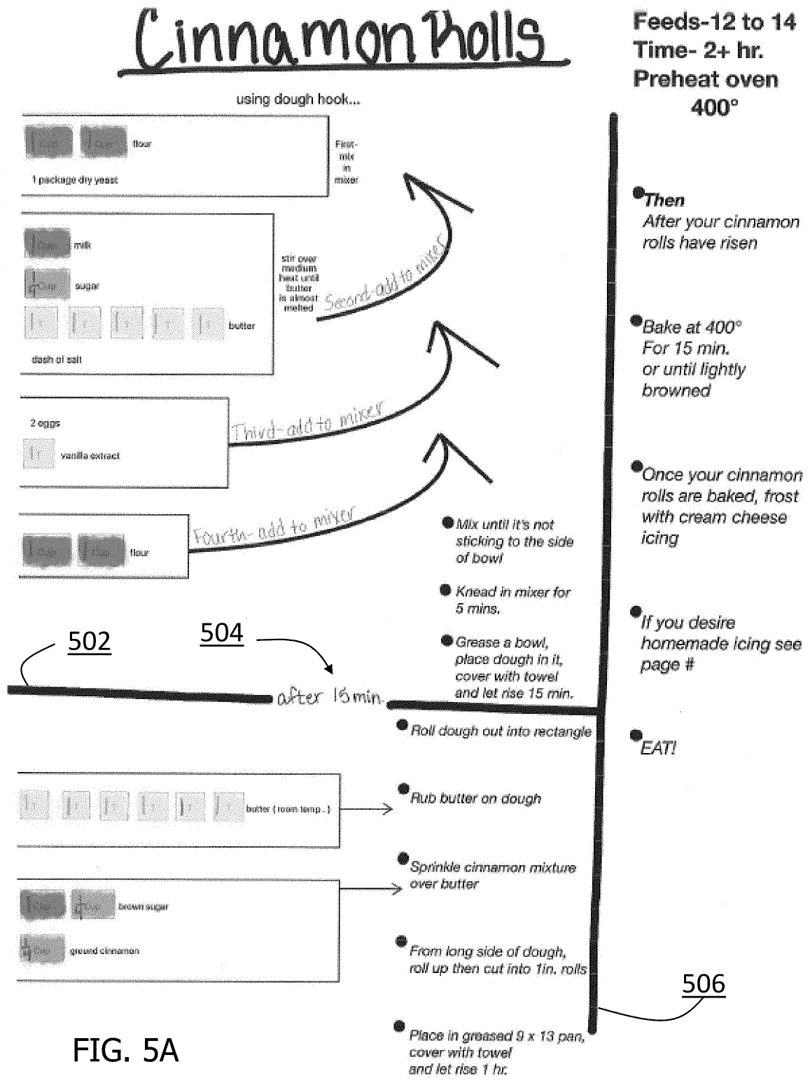

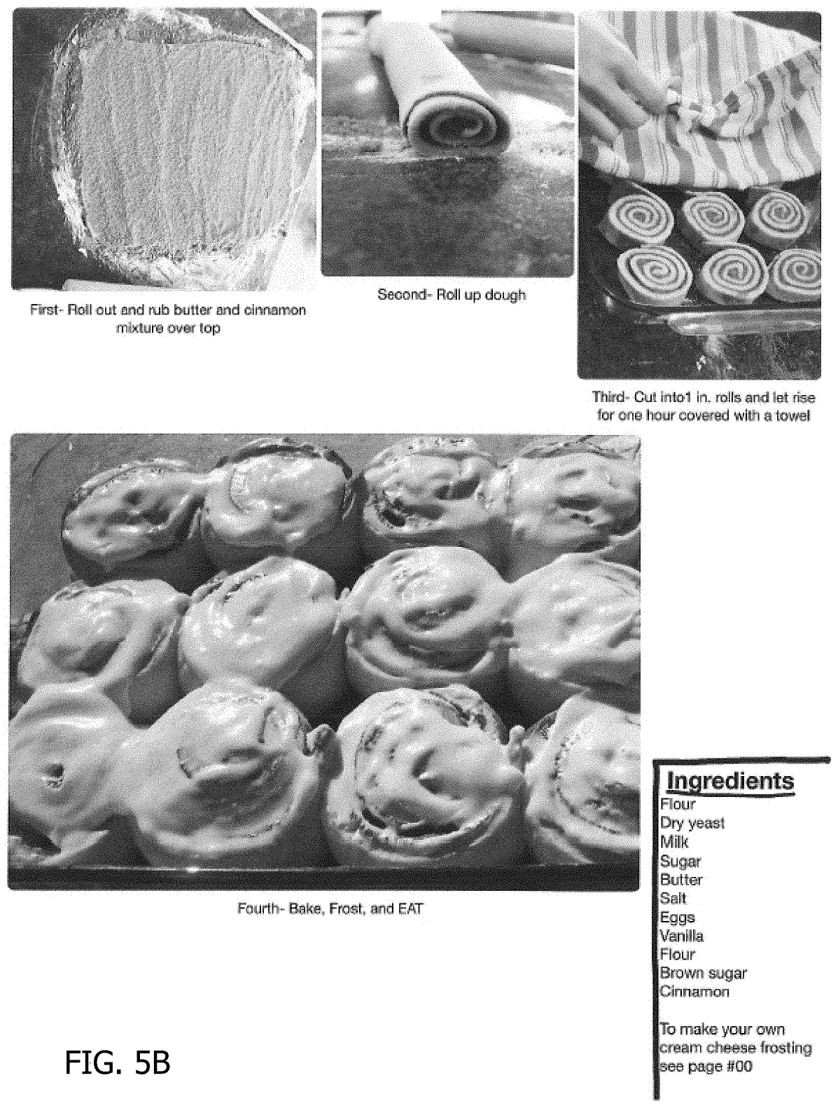

FIGS. 5A and 5B show an exemplary embodiment of a recipe for cinnamon rolls in accordance with the present disclosure. FIG. 5A includes color-coded measurement amounts, demarcated ingredient sections, bullet points, directional arrows, action-dividing lines, recipe information, non-color-coded measurements, and ample spacing. Specifically, a horizontal action-dividing line 502 separates a first set of actions from a second set of actions and includes a timing indicator 504 (“after 15 min.”, in this embodiment). A vertical dividing line 506 separates the first two sets of actions involving demarcated ingredient sections from another bullet-point set of actions for the combination of all ingredients. FIG. 5B includes multiple preparation step images with limited text, a finished dish image, a shopping list, and ample spacing.

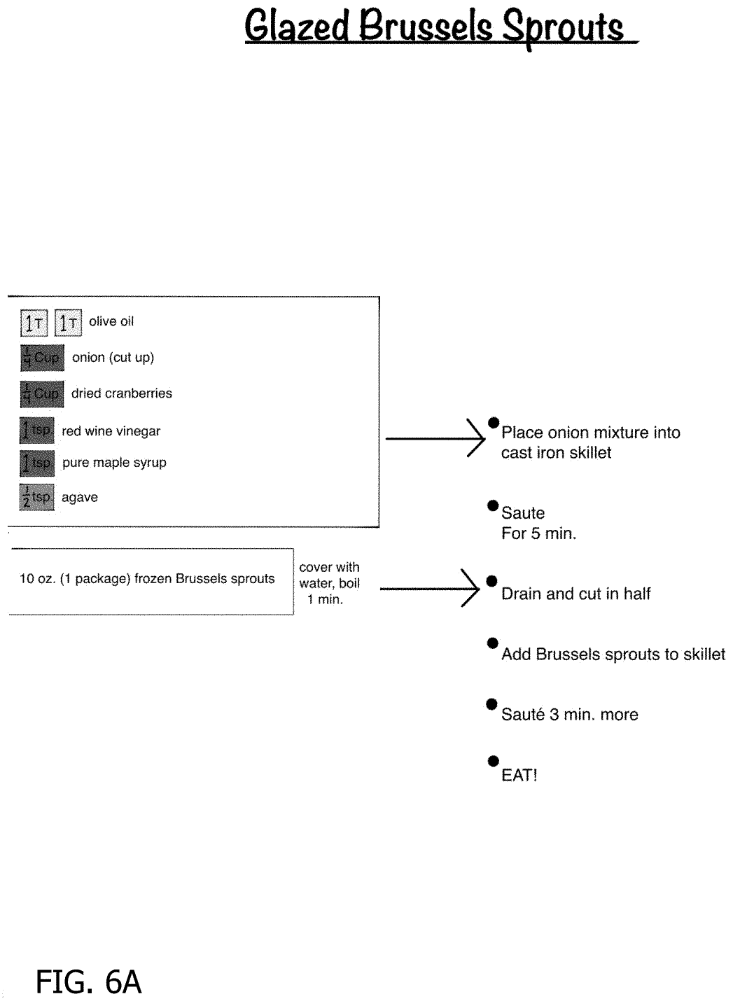

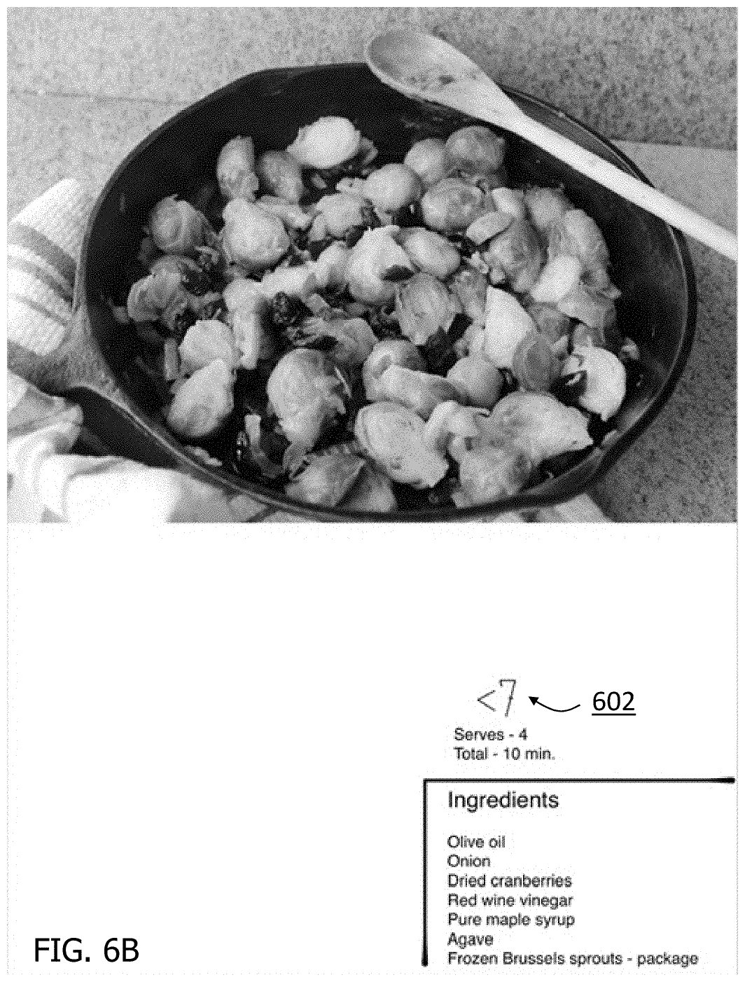

FIGS. 6A and 6B show an exemplary embodiment of a recipe for glazed brussel sprouts in accordance with the present disclosure. FIG. 6A includes color-coded measurement amounts, demarcated ingredient sections, bullet points, directional arrows, a non-color-coded measurement, and ample spacing. FIG. 6B includes a finished dish image, a shopping list, and ample spacing. Additionally, an abbreviation 602, embodied as a “less than” symbol and a number, is displayed, indicating the recipe can be prepared with seven or fewer ingredients. Recipe details (e.g., number of servings, preparation time, total time, and oven temperature) are also depicted.

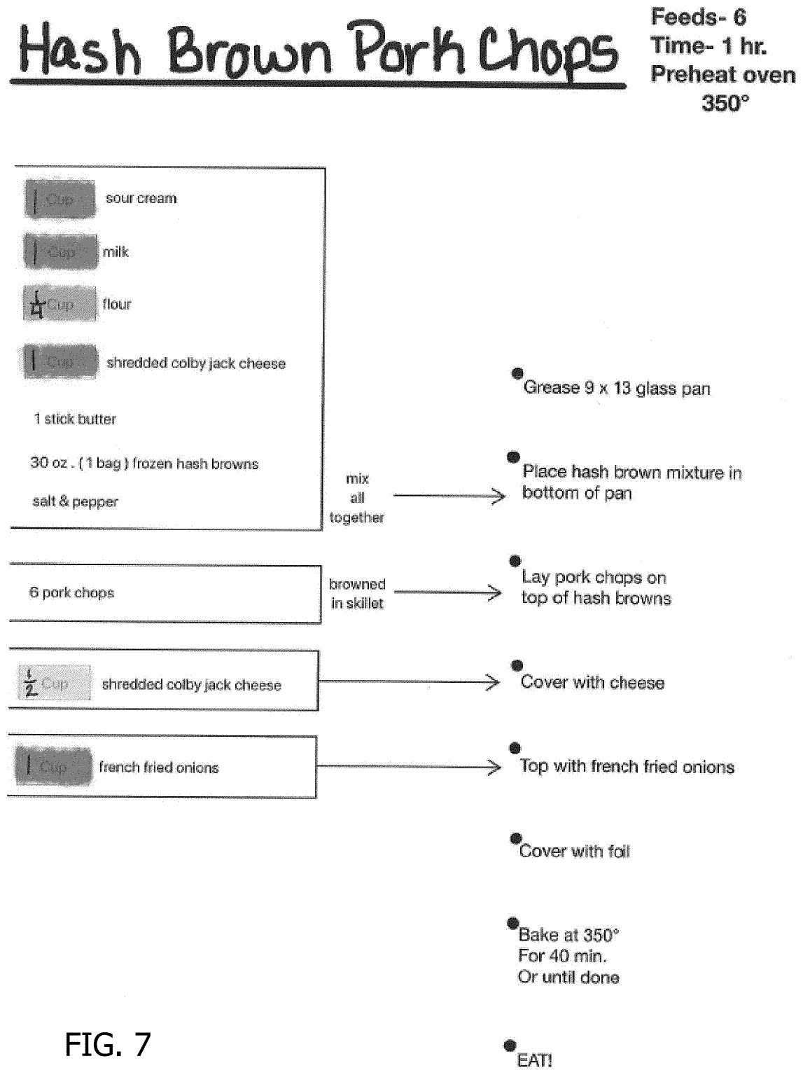

FIG. 7 shows an exemplary embodiment of a recipe for hash brown pork chops in accordance with the present disclosure. FIG. 7 includes color-coded measurement amounts, demarcated ingredient sections, bullet points, directional arrows, recipe information, non-color-coded measurements, and ample spacing. In this embodiment, the directional arrows point from demarcated ingredient sections to bullet-point action items related to the contents of those demarcated ingredient sections. For example, the demarcated ingredient section listing “6 pork chops” has an associated directional arrow. That directional arrow includes an action step (“browned in skillet”) and is pointing to a bullet-point action item related to the demarcated ingredient section (“lay pork chops on top of hash browns”). Likewise, the demarcated ingredient section listing “ [symbol] cheese” has associated directional arrow, which points to a bullet-point action item related to that ingredient (“cover with cheese”). This layout that visually associates ingredients and action enhances comprehension and readability for readers, particularly readers with reading disabilities.

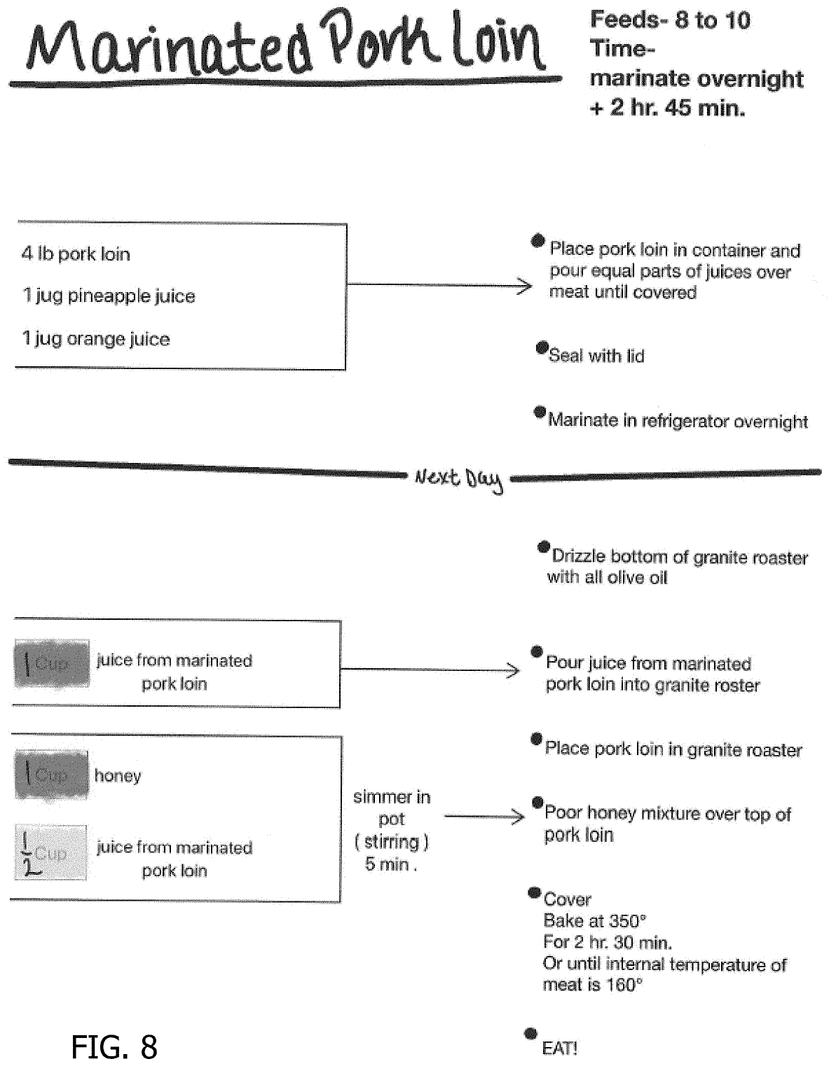

FIG. 8 shows an exemplary embodiment of a recipe for marinated pork loin in accordance with the present disclosure. FIG. 8 includes color-coded measurement amounts, demarcated ingredient sections, bullet points, directional arrows, an action-dividing line, recipe information, non-color-coded measurements, and ample spacing.

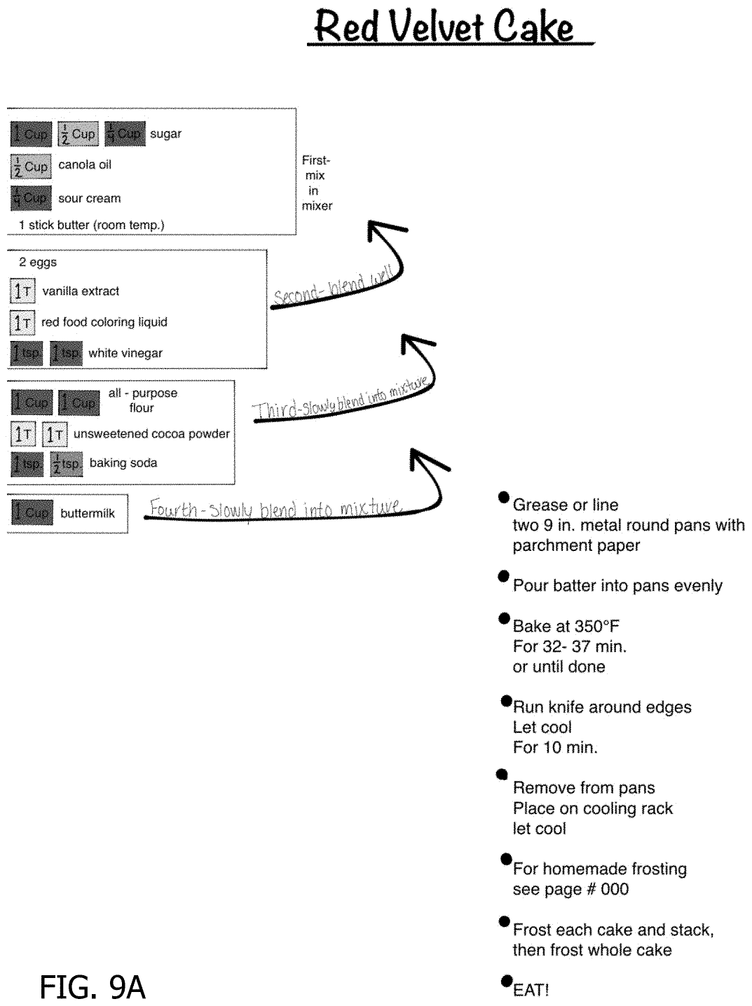

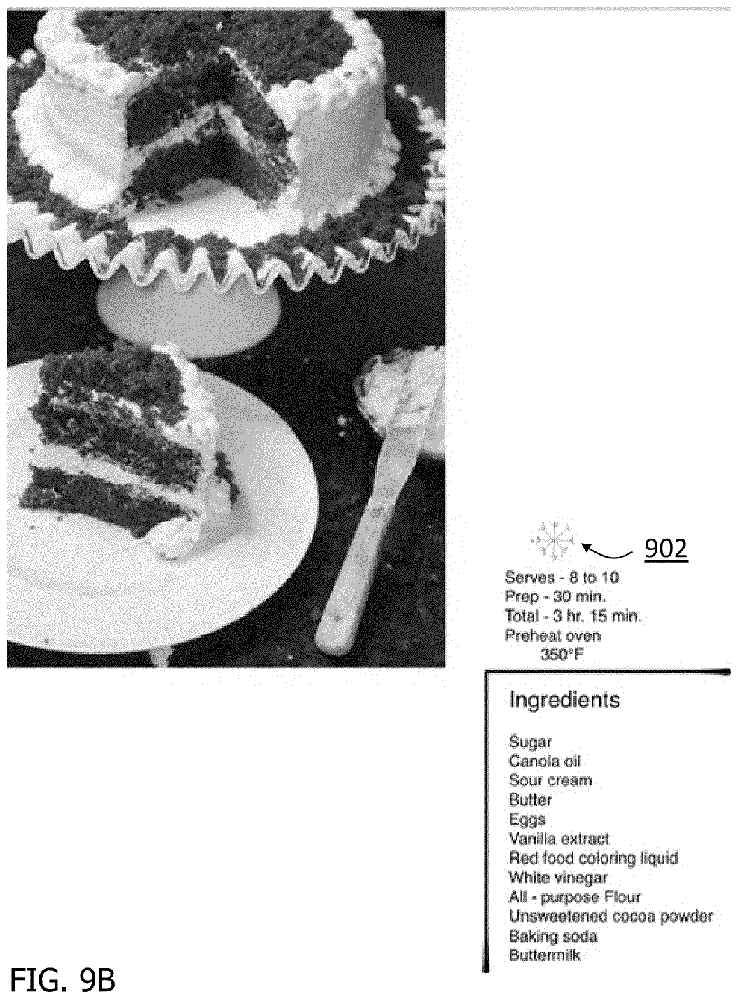

FIGS. 9A and 9B show an exemplary embodiment of a recipe for red velvet cake in accordance with the present disclosure. FIG. 9A includes color-coded measurement amounts, demarcated ingredient sections, bullet points, directional arrows, non-color-coded measurements, and ample spacing. FIG. 9B includes an image of the finished dish, a shopping list, and ample spacing. Additionally, an abbreviation 902, embodied as a snowflake icon, is displayed, indicating the recipe can be refrigerated or frozen. Recipe details (e.g., number of servings, preparation time, total time, and oven temperature) are also depicted.

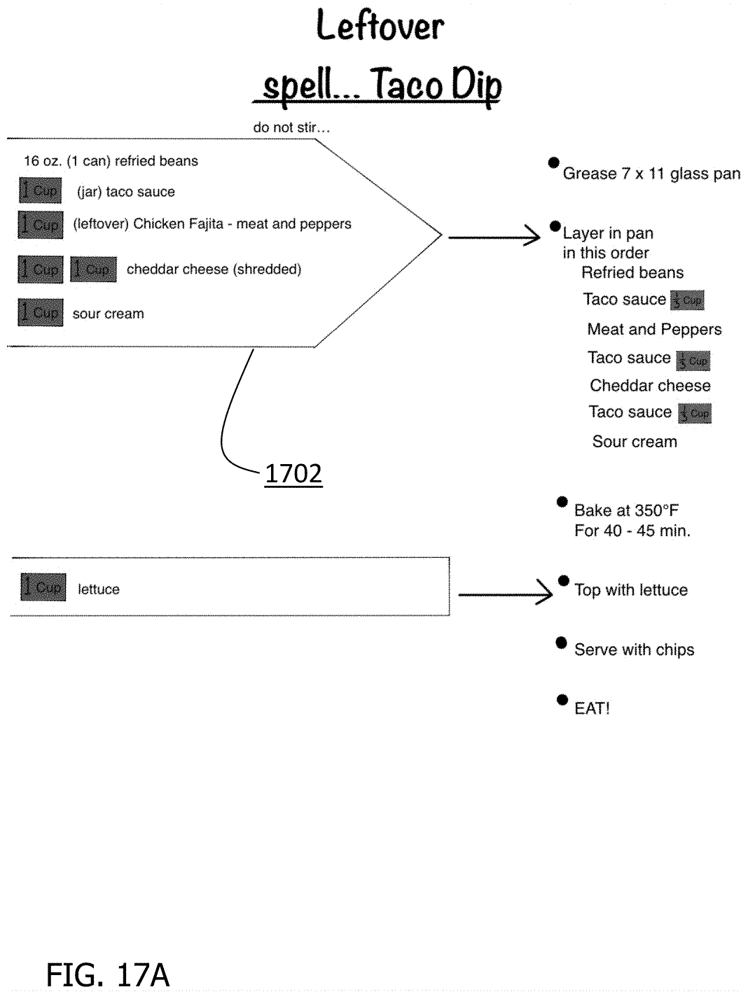

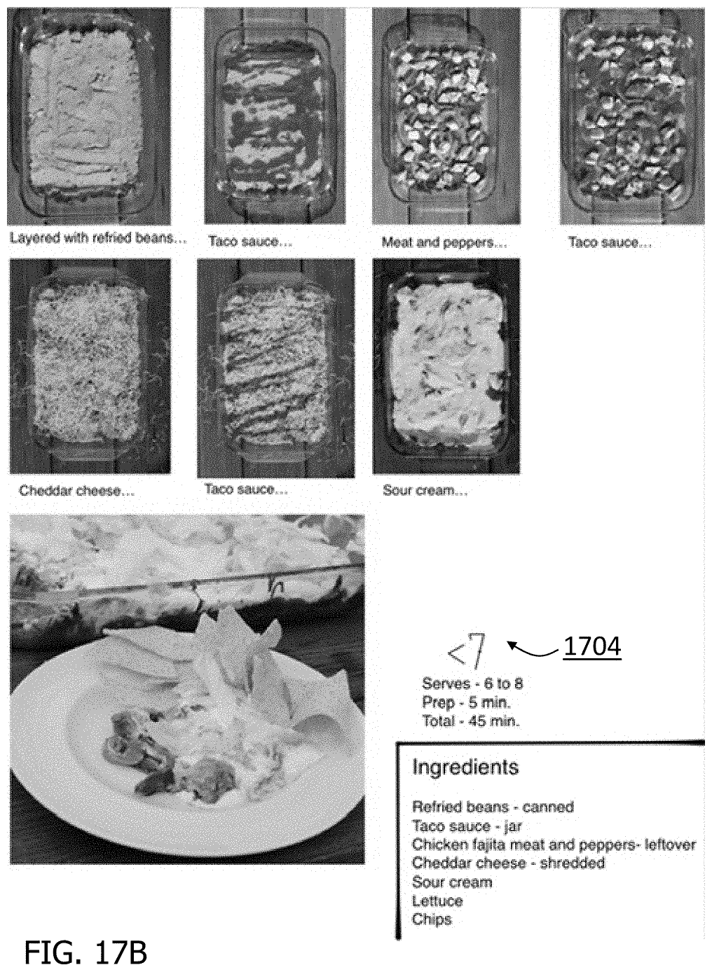

FIGS. 17A and 17B show an exemplary embodiment of a recipe for taco dip in accordance with the present disclosure. FIG. 17A includes color-coded measurement amounts, demarcated ingredient sections, bullet points, directional arrows, non-color-coded measurements, and ample spacing. In particular, a non-rectangular demarcated ingredient section 1702 is depicted. This shape of a demarcated section, in some embodiments, is used to indicate ingredients that are not mixed together but instead are layered. FIG. 17B includes multiple preparation step images with limited text, a finished dish image, a shopping list, and ample spacing. Additionally, an abbreviation 1704, embodied as a “less than” symbol and a number, is displayed, indicating the recipe can be prepared with seven or fewer ingredients. Recipe details (e.g., number of servings, preparation time, total time) are also depicted.

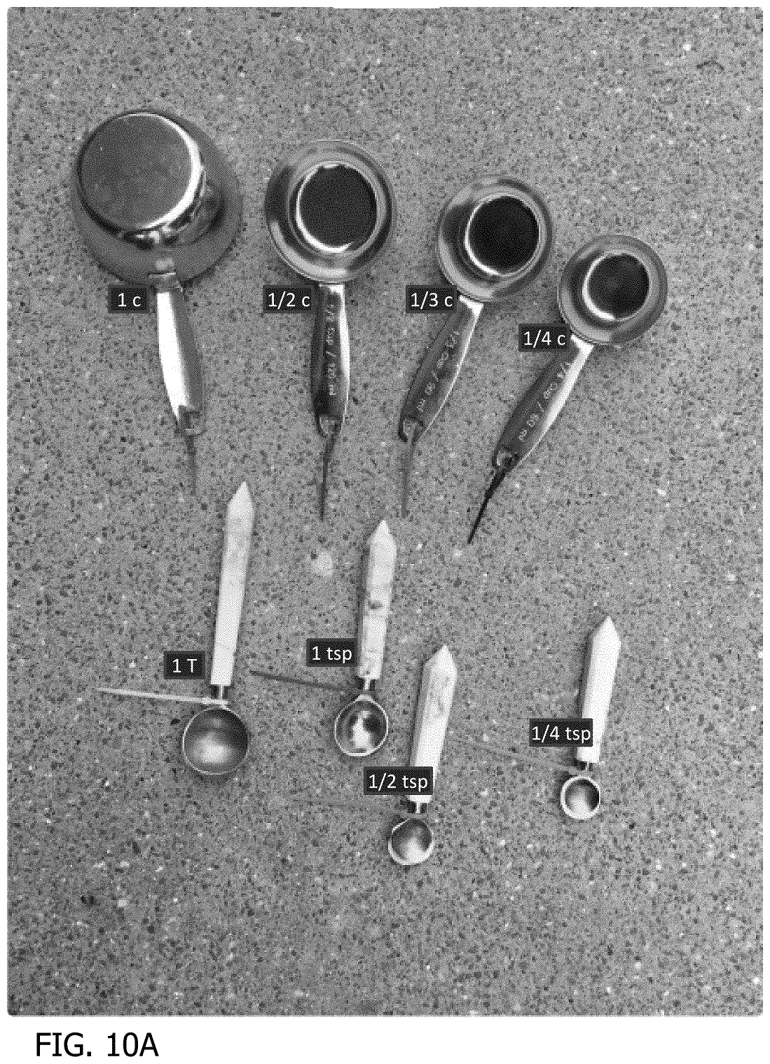

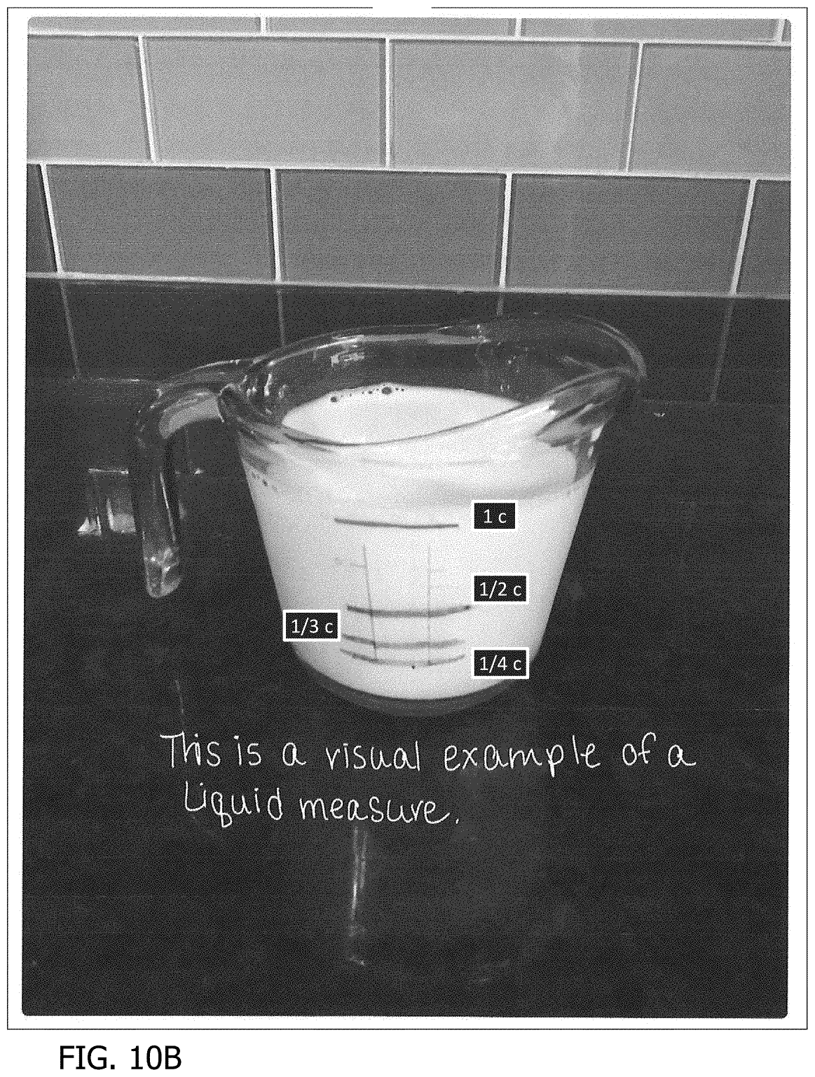

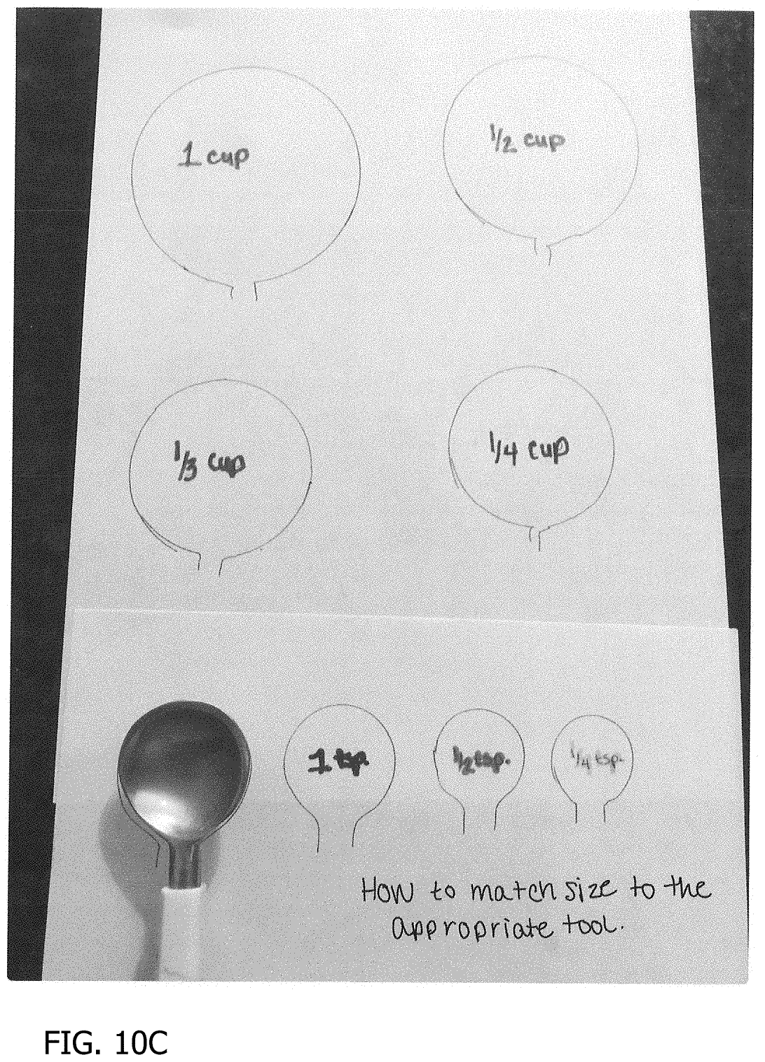

FIGS. 10A-C show exemplary embodiments of measurement identifiers in accordance with the present disclosure. FIG. 10A shows colored zip ties attached to the respective measurement tool according to the color-coded measurement amounts shown in the recipes of FIGS. 1-9B, 11-13, 17A, and 17B. FIG. 10B shows liquid measurement identifiers integrated into the respective measurement tool according to the color-coded measurement amount shown in the recipes of FIGS. 1-9B, 11-13, 17A, and 17B. In some embodiments, the measurement identifiers on the liquid measuring tool correspond (i.e., have the same color and/or shape) to the dry measuring tool identifier having the same size measurement. FIG. 10C shows how to match a measurement tool to a respective color in order to attach the color-coded measurement identifiers. For example, when colored zip ties are provided as the measurement identifiers, an illustration similar to that shown in FIG. 10C is also provided to the user for aid in matching measuring tool sizes with their respective color-coded identifier according to the recipe or cookbook.

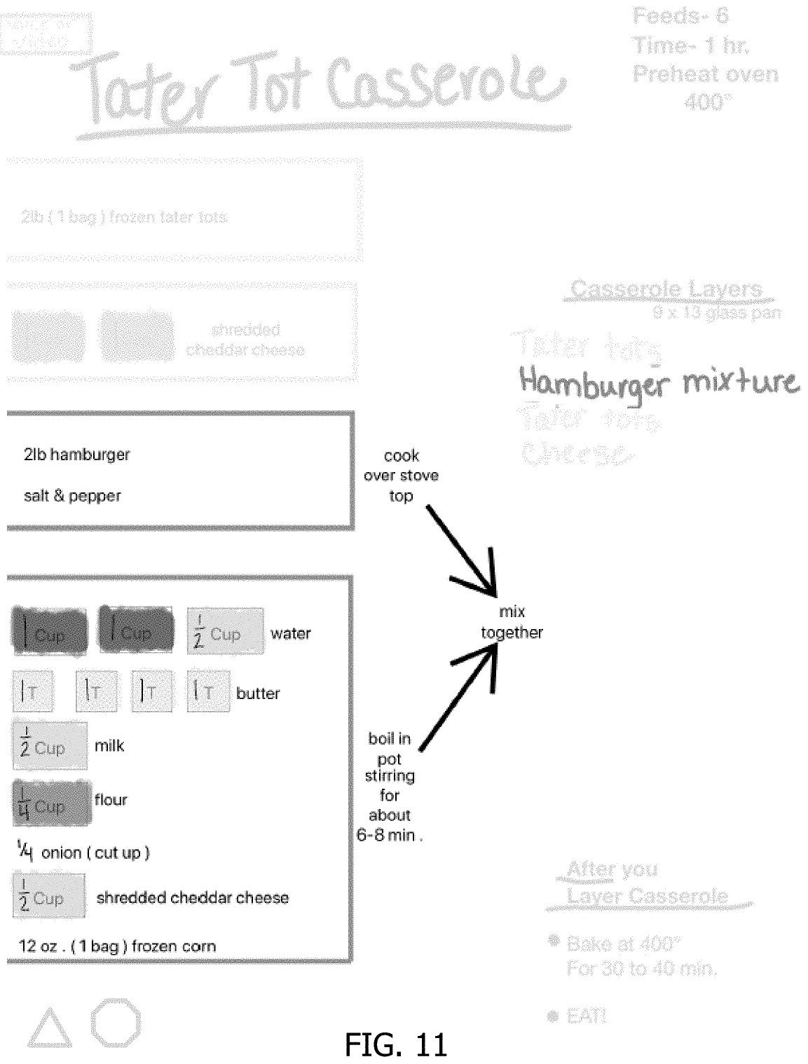

FIG. 11 shows an exemplary embodiment of a layering feature in a recipe for tater tot casserole in accordance with the present disclosure. Prior to activation of the layering feature, graphical elements including text, shapes, lines, color, etc. appear as shown in FIG. 1A. Following activation of the layering feature (e.g., by selecting a layer listed in the assembly section of a recipe displayed on an electronic device and/or as part of an electronic cookbook), a particular layer of an assembly section, such as the ‘hamburger mixture’ layer is essentially highlighted or visually emphasized by dimming the components of the recipe that are not directly associated with the hamburger mixture. In some embodiments, upon deactivation of the layering feature, such as by selecting the ‘hamburger mixture’ layer again, the entire recipe components become equally visible with the hamburger mixture and its associated ingredients and/or preparation steps (as shown in FIG. 1A). In some embodiments, selecting a different area of the recipe causes different display results. For example, selection of a different layer of the assembly section causes a different layer and associated visual components to be highlighted or visually emphasized. Based on which area, feature, or visual component(s) is/are currently highlighted or visually emphasized, selection of a different area, feature, or visual component(s) or a graphical icon (e.g., the triangular icon 116 or the “stop” icon 118, both shown in FIG. 1C) causes different display results.

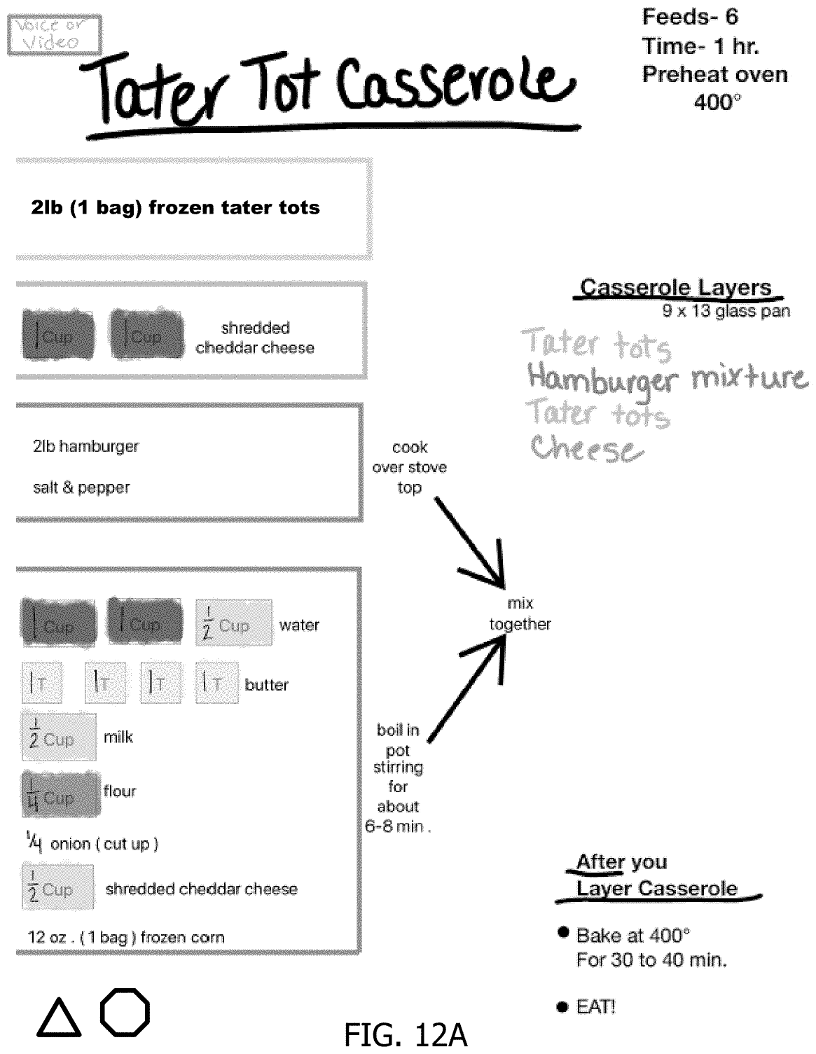

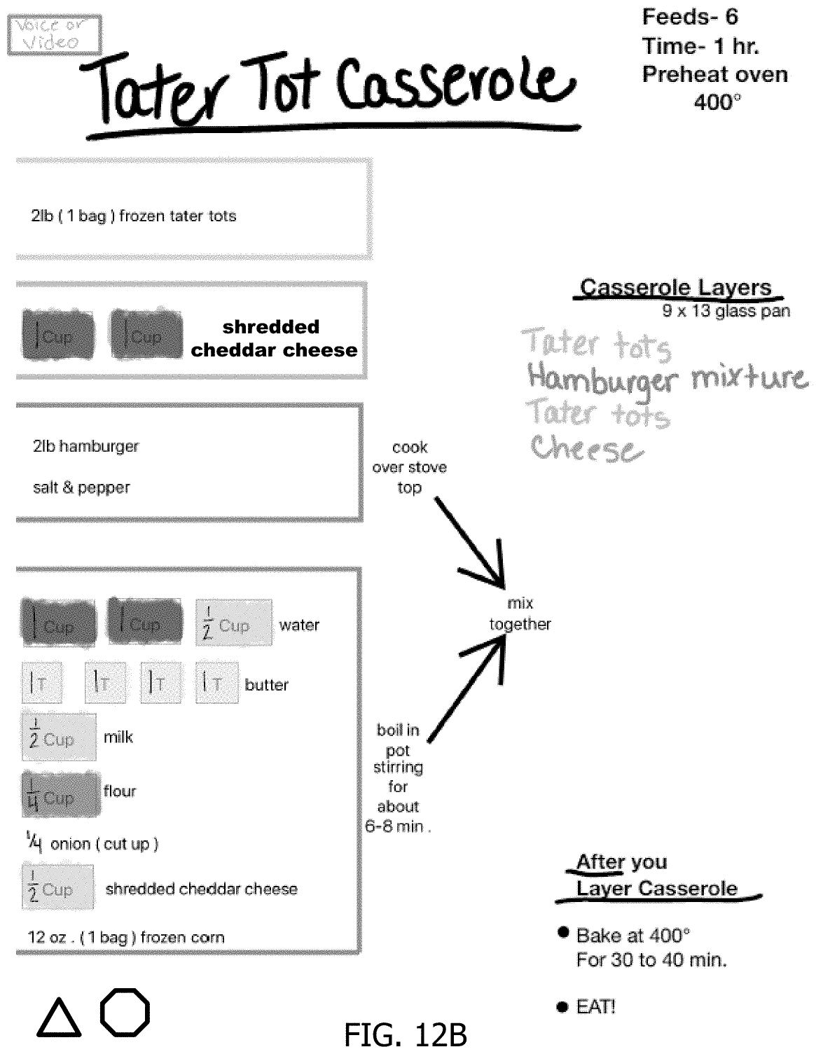

FIGS. 12A and 12B show an exemplary embodiment of a bolding feature in a recipe for tater tot casserole in accordance with the present disclosure. Prior to activation of the bolding feature, graphical elements including text, shapes, lines, color, etc. appear as shown in FIG. 1A. Following activation of the bolding feature (e.g., by selecting an ingredient or a ‘next’ button of a recipe displayed on an electronic device and/or as part of an electronic cookbook), a particular ingredient and its corresponding measurement becomes bolded and/or visually larger and/or highlighted (e.g., by a text color change, by a text background color change, etc.). FIG. 12A shows the ingredient ‘2 lb (1 bag) frozen tater tots’ in bolded text. In some embodiments, the bolded ingredient becomes un-bolded either manually (e.g., by selecting the ingredient by touching) or automatically after a certain amount of time as described herein above. Another ingredient of the recipe, such as the next listed ingredient (and its corresponding measurement), can subsequently be bolded upon either manual activation (e.g., by touching the ingredient) or automatically following un-bolding of a previous ingredient. FIG. 12B shows a subsequent recipe display where the ‘2 lb (1 bag) frozen tater tots’ is un-bolded and the next ingredient ‘ [symbol] [symbol] shredded cheddar cheese’ is now bolded. In some embodiments, selecting a different area of the recipe causes different display results. For example, selection of a different demarcated ingredient sections causes that demarcated ingredient section and any associated instructions (e.g., bullet-point action items) to be highlighted or visually emphasized. As another example, selection of the triangular graphical icon (e.g., icon 116, as shown in FIG. 1C) will advance the recipe to whatever step sequentially follows a currently highlighted step. As a further example, selection of a particular ingredient (e.g., within an ingredient list, shopping list, or demarcated ingredient section) causes display of one or more images of that ingredient. That is, interaction with different parts of the displayed recipe, and/or interaction with different parts of the displayed recipe in a different order, results in different visual changes. Certain features of a displayed recipe may be related, such as a demarcated ingredient section and its associated bullet-point action item. In such cases, selection of either the demarcated ingredient section or the associated bullet-point action item may cause the same display result (e.g., those related features to be visually enhanced).

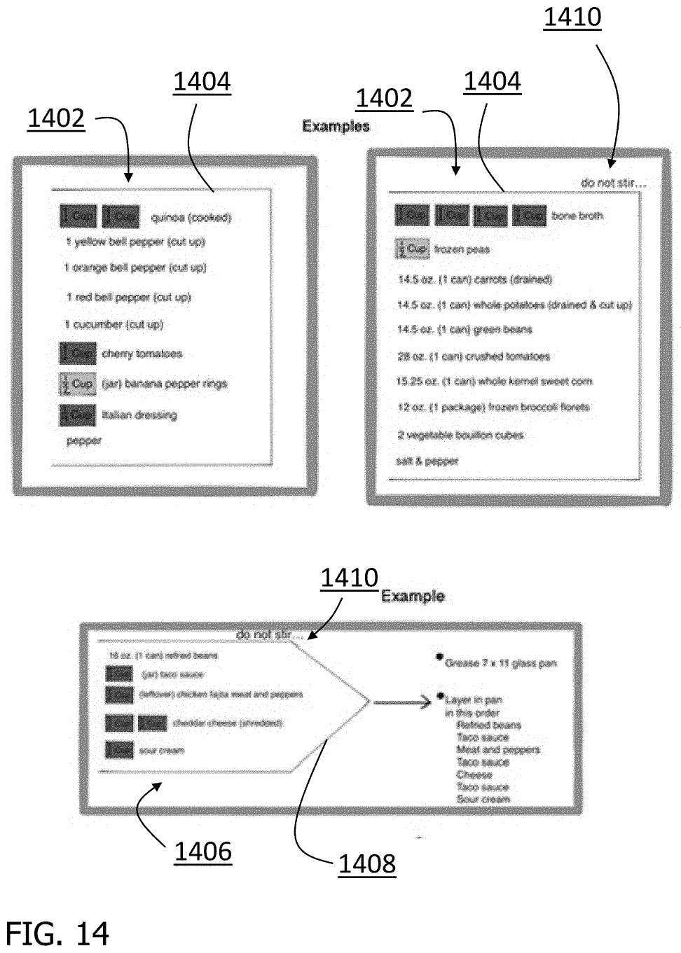

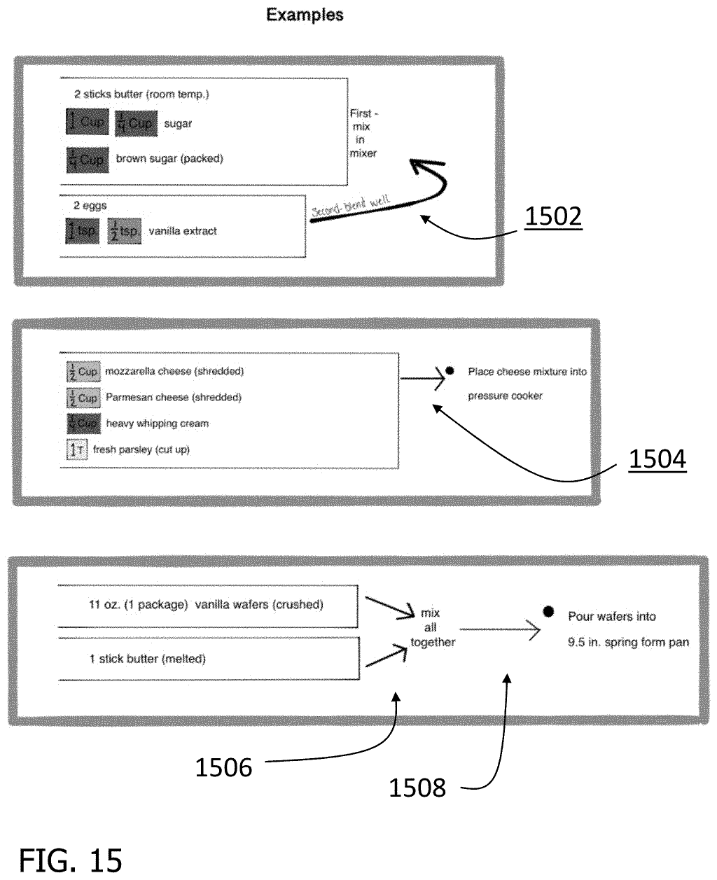

FIGS. 14 and 15 are provided for additional explanation of some features of the exemplary cookbook disclosed herein.

FIG. 14 depicts exemplary demarcated ingredient sections. Some demarcated ingredient sections 1402 are bounded by open demarcation lines 1404 shaped as three-sided open boxes or rectangles. As described herein, these demarcated ingredient sections 1402 represent groups of ingredients that are mixed together, placed together, or other associated with one another in one step of a recipe. Other demarcated ingredient sections 1406 are bounded by open demarcation lines 1408 that are linear above and below the ingredients and include an angular shape on the right side thereof. As described herein, these demarcated ingredient sections represent ingredients that are not mixed but instead are layered. The demarcated ingredient sections 1402, 1406 may include not only their associated demarcation lines but also text-based instructions 1410, in some cases.

FIG. 15 depicts exemplary direction arrows to depict their varying configurations. As described herein, the location, shape, and direction of each directional arrow are configured to assist the user in reading and interpreting the recipe while reducing the number of words required to explain the actions in the recipe. In FIG. 15, a first directional arrow 1502 is curved, points from one demarcated ingredient section to another, and includes instructional text. A second directional arrow 1504 is straight, and points from a demarcated ingredient section to a bullet-point action item related to the ingredients listed in that demarcated ingredient section. Third directional arrows 1506 are straight, and point from two separate demarcated ingredient sections, to a first text-based instruction related to the ingredients listed in those demarcated ingredient sections. A fourth directional arrow 1508 is straight and points from the previous text-based instruction to a bullet-point action item related to the result of the previous text-based instruction. In some other embodiments, a directional arrow may point downward, relative to a displayed page, representing the addition of a previous set of ingredients into a later set of ingredients. As one example, a recipe may call for heating sugar, and the sugar is identified in a first demarcated ingredient section. Text-based instructions call for heating the sugar in a pan. A directional arrow points from that instruction in a downward direction to a second demarcated ingredient section listing eggs, as the heated sugar is added to the eggs, not the other way around. In this way, the directional arrows of the present disclosure greatly enhance visual comprehension of the order and movement of a recipe while limiting the number of words that must be read and understood.

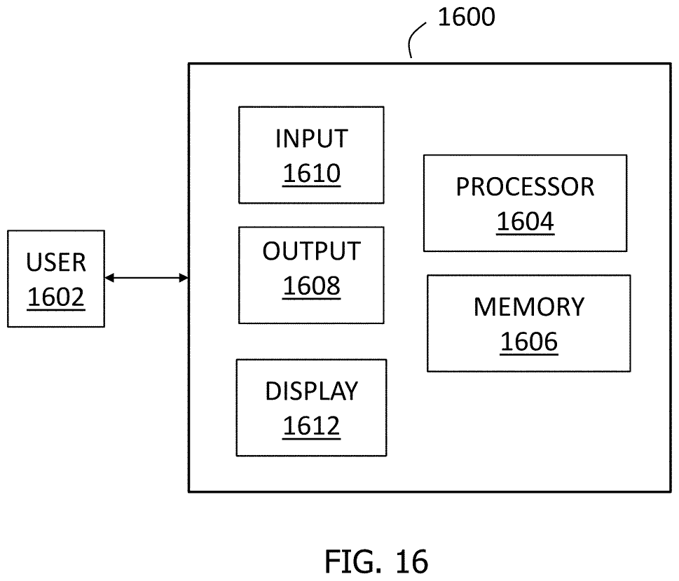

FIG. 16 illustrates an exemplary configuration of an electronic user computing device 1600, operated by a user 1602 such as a reader. The computing device 1600 includes a processor 1604 for executing instructions. In some embodiments, executable instructions are stored in a memory area 1606. The processor 1604 may include one or more processing units (e.g., in a multi-core configuration). The memory area 1606 is any device allowing information such as executable instructions and/or other data to be stored and retrieved. The memory area 1606 may include one or more computer readable media.

The computing device 1600 also includes at least one media output component 1608 for presenting information to the reader 1602. The media output component 1608 is any component capable of conveying information to the reader 1602. In some embodiments, the media output component 1608 includes an output adapter such as a video adapter and/or an audio adapter. An output adapter is operatively coupled to the processor 1604 and operatively couplable to an output device such as a display device 1612 (e.g., a liquid crystal display (LCD), organic light emitting diode (OLED) display, cathode ray tube (CRT), or “electronic ink” display) or an audio output device (e.g., a speaker or headphones).

In some embodiments, the computing device 1600 includes an input device 1610 for receiving input from the reader 1602. The input device 1610 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen (e.g., a touch-screen display 1612) may function as both the input device 1610 and an output device of the media output component 1608. Stored in the memory area 1606 are, for example, computer-executable instructions that cause the processor 1604 to perform various functions, such as for providing a user interface to the reader 1602 via media output component 1608 and/or display 1612 and, optionally, receiving and processing input from the input device 1610 an/or display 1612.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic cookbook configured for display on a display of a computing device, the electronic cookbook comprising computer-executable instructions that, upon execution by at least one processor of the computing device, cause the at least one processor to:
display an interactive first graphical user interface (GUI) on the display of the user computing device, the first GUI comprising:
a recipe including at least one color-coded measurement and at least one demarcated ingredient section, wherein a first feature of the recipe is visually enhanced relative to a second feature of the recipe; and
a graphical icon to advance the recipe;
receive, as user input to the display of the user computing device, first user input relative to the graphical icon; and
in response to the first user input, display an interactive second GUI, the second GUI comprising:
the recipe, wherein the second feature of the recipe is visually enhanced relative to the first feature of the recipe, the second feature sequentially following the first feature in performing the recipe.

2. The electronic cookbook of claim 1, wherein the visual enhancement of either the first feature or the second feature includes at least one of bolding, highlighting, and expanding.

3. The electronic cookbook of claim 1, wherein the first feature, the second feature, and the graphical icon are each interactive, and the computer-executable instructions cause the at least one processor to display the recipe in different ways depending on which of the first feature, the second feature, and the graphical icon are selected and/or the order of the selection thereof.

4. The electronic cookbook of claim 1, wherein the at least one color-coded measurement is further shape-coded.

5. The electronic cookbook of claim 1, wherein the recipe displayed on the first GUI further includes at least one image selected from an ingredient image, a preparation step image, a completed recipe image, and combinations thereof.

6. The electronic cookbook of claim 1, wherein the recipe displayed on the first GUI further includes at least one of a directional arrow indicating a preparation step of the recipe, a demarcated ingredient section demarcated by color, a demarcated ingredient section demarcated by lines, and combinations thereof.

7. The electronic cookbook of claim 1, wherein a layout of the first GUI and the second GUI is designed to enhance readability of the recipe for users with a learning disability including at least one of a reading disorder, a language comprehension deficit, a phonological deficit, an orthographic processing deficit, a vocabulary weakness, and a generalized language learning disorder, and wherein the reading disorder comprises at least one of dyslexia and alexia.

8. The electronic cookbook of claim 1, wherein the recipe includes bullet-point action items related to the steps of performing the recipe, each bullet-point action item including a limited number of words arranged in a limited number of lines.

9. The electronic cookbook of claim 1, wherein the recipe includes text having a size, capitalization, or placement related to the content of the text.

10. The electronic cookbook of claim 1, wherein the first feature includes a first action step associated with a first demarcated ingredient section including a first color-coded measurement, and the second feature includes second demarcated ingredient section and a directional arrow pointing from the second demarcated ingredient section to the first demarcated ingredient section.

11. The electronic cookbook of claim 1, wherein the first feature a first demarcated ingredient section including a first color-coded measurement, and the second feature includes second demarcated ingredient section and a directional arrow pointing from the second demarcated ingredient section to an action step associated with the second demarcated ingredient section.

12. A method for providing an electronic cookbook for display on a display of a computing device including at least one processor and at least one memory, the method comprising:
displaying, by the at least one processor, an interactive first graphical user interface (GUI) on the display of the user computing device, the first GUI comprising:
a recipe including at least one color-coded measurement and at least one demarcated ingredient section, wherein a first feature of the recipe is visually enhanced relative to a second feature of the recipe; and
a graphical icon to advance the recipe;
receiving, by the at least one processor, as user input to the display of the user computing device, first user input relative to the graphical icon; and
in response to the first user input, displaying, by the at least one processor, an interactive second GUI, the second GUI comprising:
the recipe, wherein the second feature of the recipe is visually enhanced relative to the first feature of the recipe, the second feature sequentially following the first feature in performing the recipe.

13. The method of claim 12, displaying the visually enhanced first feature or second feature comprises displaying the first feature or the second feature with at least one of bolding, highlighting, and expanding relative to the other of the first feature or the second feature.

14. The method of claim 12, wherein the first feature, the second feature, and the graphical icon are each interactive, and methods further includes displaying, by the at least one processor on the display, the recipe in different ways depending on which of the first feature, the second feature, and the graphical icon are selected and/or the order of the selection thereof.

15. The method of claim 12, wherein displaying the first GUI comprises displaying the first GUI including the recipe further including at least one image selected from an ingredient image, a preparation step image, a completed recipe image, and combinations thereof.

16. The method of claim 12, wherein displaying the first GUI comprises displaying the first GUI including the recipe at least one of a directional arrow indicating a preparation step of the recipe, a demarcated ingredient section demarcated by color, a demarcated ingredient section demarcated by lines, and combinations thereof.

17. The method of claim 12, wherein displaying the first GUI and the second GUI comprises displaying, according to computer-executable instructions, a layout of the first GUI and the second GUI with enhanced readability of the recipe for users with a learning disability including at least one of a reading disorder, a language comprehension deficit, a phonological deficit, an orthographic processing deficit, a vocabulary weakness, and a generalized language learning disorder, and wherein the reading disorder comprises at least one of dyslexia and alexia.

18. The method of claim 12, wherein displaying the first GUI comprises displaying the first GUI including the recipe further including bullet-point action items related to the steps of performing the recipe, each bullet-point action item including a limited number of words arranged in a limited number of lines.

19. The method of claim 12, wherein displaying the first GUI comprises displaying the first GUI including the recipe further including text having a size, capitalization, or placement related to the content of the text.

20. The method of claim 12, wherein displaying the first GUI comprises one of:
displaying the recipe including the first feature including a first action step associated with a first demarcated ingredient section including a first color-coded measurement, and the second feature including second demarcated ingredient section and a directional arrow pointing from the second demarcated ingredient section to the first demarcated ingredient section; or
displaying the recipe including the first feature including a first demarcated ingredient section including a first color-coded measurement, and the second feature including second demarcated ingredient section and a directional arrow pointing from the second demarcated ingredient section to an action step associated with the second demarcated ingredient section.
